(19) United States
(12) Patent Application Publication
(10) Pub. No.: US 2015/0199427 A1
(43) Pub. Date: Jul. 16, 2015

(54) DOCUMENT ANALYSIS APPARATUS AND PROGRAM

(71) Applicants: Kabushiki Kaisha Toshiba, Minato-ku (JP); Toshiba Solutions Corporation, Kawasaki-shi (JP)

(72) Inventors: Yasunari MIYABE, Chofu (JP); Shigeru MATSUMOTO, Nishitokyo (JP); Kazuyuki GOTO, Kawasaki (JP); Hideki IWASAKI, Fuchu (JP); Shozo ISOBE, Kawasaki (JP)

(73) Assignees: Kabushiki Kaisha Toshiba, Minato-ku (JP); Toshiba Solutions Corporation, Kawasaki-shi (JP)

(21) Appl. No.: 14/669,721

(22) Filed: Mar. 26, 2015

Related U.S. Application Data
(63) Continuation-in-part of application No. PCT/JP2012/074688, filed on Sep. 26, 2012.

(51) Int. Cl. G06F 17/30

(52) U.S. Cl. CPC G06F 17/30684; G06F 17/30696

(57) ABSTRACT

A document analysis apparatus according to an embodiment an acquisition unit acquires a plurality of words by analyzing a text included in each of a plurality of documents stored in a document storage unit. A first determination unit determines, for each of the acquired words, the presence/absence of a correlation between the word and at least two attributes designated by a user out of a plurality of attributes of the plurality of documents stored in the document storage unit. A second determination unit determines whether a determination result by the first determination unit matches a pattern designated by the user out of a plurality of patterns stored in a pattern storage unit. A presentation unit presents a word whose determination result by the first determination unit is determined to match the pattern designated by the user.

### CROSS-REFERENCE TO RELATED APPLICATIONS

This application is a Continuation Application of PCT application No. PCT/JP2012/074688, filed on Sep. 26, 2012, the entire contents of which are incorporated herein by reference.

### FIELD

Embodiments described herein relate generally to a document analysis apparatus and a program for analyzing a digitized document group.

### BACKGROUND

Along with the recent sophistication of information systems, it is possible to record and store an enormous number of digitized documents (to be simply referred to as documents hereinafter) of, for example, patent literatures, news articles, web pages, or books. There is a demand for effectively utilizing the accumulated document groups in daily activities.

As a specific example of effective utilization of document groups, for example, an enormous number of news articles are classified and organized for easy use to many people, or patent literatures related to a technology currently under research and development are classified, thereby analyzing the trends in the patent groups of the user's company and other companies and finding new research and development fields.

That is, it is preferable to classify (organize) an enormous number of documents in accordance with the contents from the viewpoint of effective utilization of information.

Documents as described above have, for example, a plurality of attributes, and each of the attributes has the value of the attribute (to be referred to as an attribute value hereinafter). If a document is, for example, a patent literature, the document has attributes such as body (for example, abstract), applicant, and filing date. Each of the attributes of body, applicant, and filing date of the document has an attribute value corresponding to the attribute. Note that out of the attributes of a document, an attribute including a text (aggregate of character strings in an entire article) formed from words, like a body, is called a text attribute, an attribute having a discontinuous value (discrete value) as an attribute value, like an applicant, is called a discrete value attribute, and an attribute having a continuous value without any break, like a filing date, is called a continuous value attribute. If a document has the attributes, the document can be classified into each category by the attribute values of the attributes (words appearing in the body, the company as the applicant, and the filing date).

For example, when analyzing a trend by combining the texts of an enormous number of documents and a plurality of attributes linked to the documents, the user may want to obtain a finding that the contents of a certain text unevenly appear by a plurality of attributes. More specifically, when performing benchmark analysis of patents by setting the text to the abstract, the discrete value attribute to the applicant, and the continuous value attribute to the filing date, the user may want to know the period and technology for which the user's company has significantly applied for many patents as compared to other companies.

In Jpn. Pat. Appln. KOKAI Publication No. 2011-198111, however, feature words are extracted based on one attribute, instead of extracting feature words in consideration of two attributes such as a continuous value and a discrete value, as in the above example. When two or more attributes are used, analysis is performed by combining a text and two attributes. For this reason, more trial and error is necessary as compared to a case where one attribute is used.

Jpn. Pat. Appln. KOKAI Publication No. 2010-061176 is limited to a rule that a word and all attributes such as a date of user's interest unevenly appear, and it may be impossible to obtain a finding that meets a user's purpose. For example, assume that a user wants to know the contents of frequent inquiries commonly made concerning a certain product during a specific period (that is, a combination pattern representing that a word and a date appear unevenly, but the word and the product of inquiry appear evenly). However, since Jpn. Pat. Appln. KOKAI Publication No. 2010-061176 is limited to the rule that all attributes unevenly appear, attribute combinations in a case without uneven word appearance cannot be analyzed, and a finding that meets the user's purpose cannot be obtained.

It is an object of the present invention to provide a document analysis apparatus capable of efficiently obtaining a finding desired by a user, and a program.

### BRIEF DESCRIPTION OF THE DRAWINGS

FIG. 1 is a block diagram showing the hardware arrangement of a document analysis apparatus according to an embodiment.

FIG. 2 is a block diagram mainly showing the functional arrangement of a document analysis apparatus 10 according to the embodiment.

FIG. 3 is a view showing an example of the data structure of a document stored in a document storage unit 100 shown in FIG. 2.

FIG. 4 is a view showing an example of the data structure of category information representing the category of the root in the hierarchical structure of categories.

FIG. 5 is a view showing an example of the data structure of category information representing a category subordinate to the root category in the hierarchical structure of categories.

FIG. 6 is a view showing an example of the data structure of category information representing a category subordinate to the category represented by category information 122 shown in FIG. 5 in the hierarchical structure of categories.

FIG. 7 is a view showing an example of the data structure of category information representing a category subordinate to the root category in the hierarchical structure of categories.

FIG. 8 is a view showing an example of the data structure of category information representing a category subordinate to the category represented by category information 124 shown in FIG. 7 in the hierarchical structure of categories.

FIG. 9 is a view showing an example of the data structure of category information representing a category subordinate to the category represented by category information 124 shown in FIG. 7 in the hierarchical structure of categories.

FIG. 10 is a flowchart showing the processing procedure of the document analysis apparatus 10 according to the embodiment.

FIG. 11 is a view showing an example of a category display screen.

FIG. 12 is a view for explaining a screen displayed when a user designates various kinds of information.

FIG. 13 is a view for explaining patterns that can be designated in a pattern designation field 150h.

FIG. 14 is a view for explaining a first pattern in detail.

FIG. 15 is a view for explaining a second pattern in detail.

FIG. 16 is a view for explaining a third pattern in detail.

FIG. 17 is a view for explaining a fourth pattern in detail.

FIG. 18 is a flowchart showing the processing procedure of word pattern determination processing executed by a word pattern determination processing unit 141.

FIG. 19 is a view for explaining correlation determination processing between a target word and a discrete value attribute.

FIG. 20 is a flowchart showing the processing procedure of analysis word extraction processing executed by an analysis word extraction unit 142.

FIG. 21 is a view for explaining words executed by the analysis word extraction unit 142.

FIG. 22 is a flowchart showing the processing procedure of cross tabulation result display processing executed by a cross tabulation visualization unit 132.

FIG. 23 is a view showing an example of a display screen when a view list output by the cross tabulation visualization unit 132 is displayed.

FIG. 24 is a view showing an example of a display screen when a word “refract” is selected.

FIG. 25 is a view showing an example of a cross tabulation result displayed as a line graph.

FIG. 26 is a view showing an example of a cross tabulation result displayed by numerical values.

### DETAILED DESCRIPTION

In general, a document analysis apparatus according to an embodiment comprises a document storage unit, a pattern storage unit, an acquisition unit, a first determination unit, a second determination unit, and a presentation unit.

The document storage unit stores a plurality of documents each of which includes a text formed from a plurality of words, has a plurality of attributes, and includes attribute values of the attributes.

The pattern storage unit stores a plurality of patterns each representing presence/absence of a correlation between a word and each of at least two attributes out of the plurality of attributes.

The acquisition unit acquires a plurality of words by analyzing the text included in each of the plurality of documents stored in the document storage unit.

The first determination unit determines, for each of the acquired words, the presence/absence of the correlation between the word and at least two attributes designated by a user out of the plurality of attributes of the plurality of documents stored in the document storage unit.

The second determination unit determines whether a determination result by the first determination unit matches a pattern designated by the user out of the plurality of patterns stored in the pattern storage unit.

The presentation unit presents a word whose determination result by the first determination unit is determined to match the pattern designated by the user.

An embodiment will now be described with reference to the accompanying drawings.

FIG. 1 is a block diagram showing the hardware arrangement of a document analysis apparatus according to this embodiment. Note that the document analysis apparatus is implemented as a hardware arrangement or a combined arrangement of hardware and software configured to implement the functions of the apparatus. The software is formed from a program that is installed from a storage medium or network in advance to cause the document analysis apparatus to implement the function.

As shown in FIG. 1, a document analysis apparatus 10 includes a storage device 11, a keyboard 12, a mouse 13, a central processing unit 14, and a display 15.

The storage device 11 is a storage device read- or write-accessible from the central processing unit 14, and is formed from, for example, a RAM (Random Access Memory). A program (document analysis program) to be executed by the central processing unit 14 is stored in the storage device 11 in advance.

The keyboard 12 and the mouse 13 are input devices, and input various kind of information formed from data or an instruction to the central processing unit 14 in accordance with, for example, an operation of the operator (user) of the document analysis apparatus 10.

The central processing unit 14 is, for example, a CPU (processor), and has a function of executing the program stored in the storage device 11, a function of controlling execution of each process based on information input from the keyboard 12 or the mouse 13, and a function of outputting the execution result to the display 15.

The display 15 is a display device, and has a function of displaying and visualizing, for example, each architecture or feature model under editing. The display 15 also has a function of displaying information output from the central processing unit 14.

Note that the document analysis apparatus 10 is implemented by, for example, a computer to which a document analysis program according to this embodiment is applied.

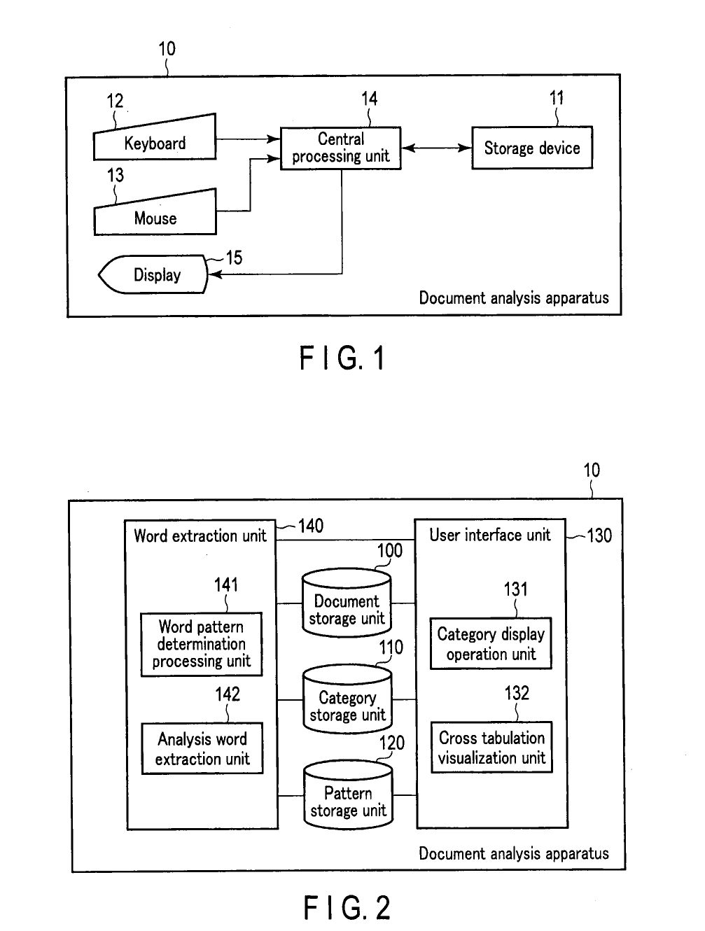

FIG. 2 is a block diagram mainly showing the functional arrangement of the document analysis apparatus 10 according to this embodiment.

As shown in FIG. 2, the document analysis apparatus 10 includes a document storage unit 100, a category storage unit 110, a pattern storage unit 120, a user interface unit 130, and a word extraction unit 140. Note that the document storage unit 100, the category storage unit 110, and the pattern storage unit 120 are stored in an external storage device (not shown) or the like. The user interface unit 130 and the word extraction unit 140 are implemented by causing the computer (central processing unit 14) of the document analysis apparatus 10 to execute the document analysis program stored in the storage device 11.

The document storage unit 100 stores a plurality of documents to be analyzed by the document analysis apparatus 10. Each document stored in the document storage unit 100 includes a text formed from a plurality of words. The document stored in the document storage unit 100 has attributes and includes the attribute values of the attributes.

The category storage unit 110 stores category information (that is, the classification result of the plurality of documents) representing categories into which the plurality of documents stored in the document storage unit 100 are classified. More specifically, the category storage unit 110 stores the result of classifying the plurality of documents stored in the document storage unit 100 based on, for example, the attribute values of the attributes of the documents.

The pattern storage unit 120 stores, in advance, a plurality of patterns representing the presence/absence of a correlation between a word and, for example, two attributes out of the attributes of the plurality of documents stored in the document storage unit 100.

Note that the document storage unit 100, the category storage unit 110, and the pattern storage unit 120 are implemented using, for example, a file system or a database.

The user interface unit 130 is a functional unit implemented using the keyboard 12, the mouse 13, and the display 15 described above, and accepts, for example, user's input information or instruction information. The user interface unit 130 includes a category display operation unit 131 and a cross tabulation visualization unit 132.

Based on the category information stored in the category storage unit 110, the category display operation unit 131 displays, on the display 15, a screen (to be referred to as a category display screen hereinafter) to present categories represented by the category information and the hierarchical structure of the categories to the user. The category display operation unit 131 also accepts a user operation (designation operation) on the category display screen presented to the user. In this case, the user can designate, on the category display screen, documents (set) to be analyzed which are stored in the document storage unit 100, texts included in the documents, for example, two attributes (first and second attributes) of the documents, and a pattern representing the presence/absence of a correlation between a word and each of the two attributes. Note that the pattern is designated from the plurality of patterns stored in the above-described pattern storage unit 120.

The cross tabulation visualization unit 132 generates a category (first category) into which the documents to be analyzed are classified based on the attribute value of one (first attribute) of the two attributes designated by the user. In addition, the cross tabulation visualization unit 132 generates a category (second category) into which the documents to be analyzed are classified based on the attribute value of the other (second attribute) of the two attributes designated by the user.

The cross tabulation visualization unit 132 generates a cross tabulation result including the number of documents classified into both of the category generated based on the attribute value of the first attribute out of the two attributes designated by the user and the category generated based on the attribute value of the second attribute.

The cross tabulation result generated by the cross tabulation visualization unit 132 is displayed on, for example, the display 15 together with words extracted by the word extraction unit 140 (to be described later). The cross tabulation result generated by the cross tabulation visualization unit 132 and the words extracted by the word extraction unit 140 are thus presented to the user.

The word extraction unit 140 includes a word pattern determination processing unit 141 and an analysis word extraction unit 142.

The word pattern determination processing unit 141 acquires a plurality of words by analyzing the texts included in the documents to be analyzed (a plurality of documents stored in the document storage unit 100) which are designated by the user.

The word pattern determination processing unit 141 determines, for each acquired word, the presence/absence of a correlation between the word and each of the two attributes designated by the user. The word pattern determination processing unit 141 determines whether the determination result matches the pattern designated by the user. The word pattern determination processing unit 141 extracts a word whose determination result matches the pattern designated by the user.

For each word extracted by the word pattern determination processing unit 141, the analysis word extraction unit 142 calculates the degree of feature based on the appearance frequency of the word in the documents to be analyzed which are designated by the user.

Additionally, for each word extracted by the word pattern determination processing unit 141, the analysis word extraction unit 142 calculates the degree of association based on the cooccurrence of the word and another word extracted by the word pattern determination processing unit 141.

The analysis word extraction unit 142 extracts a word to be presented to the user from the words extracted by the word pattern determination processing unit 141 based on the degree of feature and the degree of association calculated for each word.

Note that the word extracted by the analysis word extraction unit 142 is presented to the user by the cross tabulation visualization unit 132, as described above.

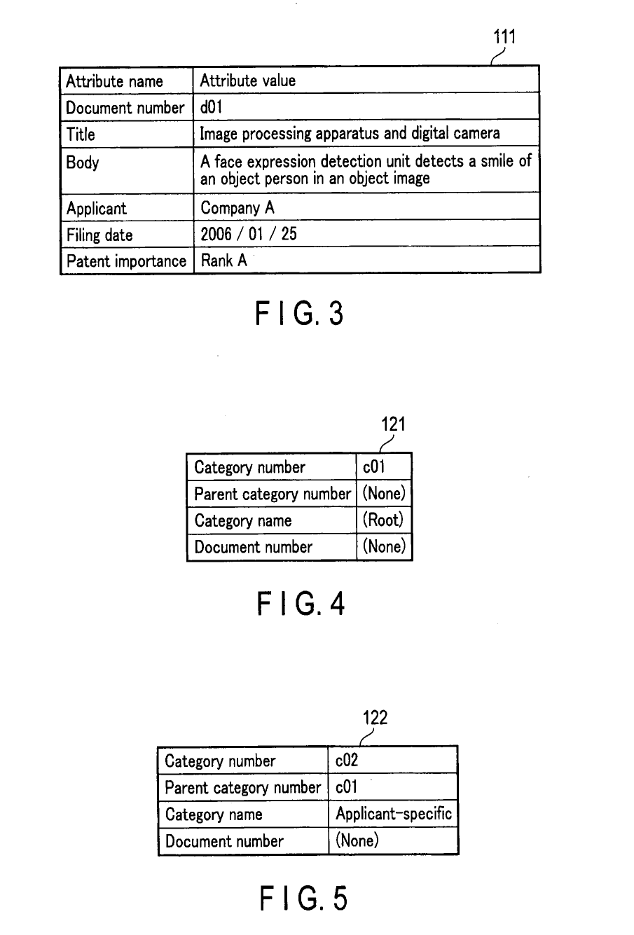

FIG. 3 shows an example of the data structure of a document stored in the document storage unit 100 shown in FIG. 2. As shown in FIG. 2, the document stored in the document storage unit 100 has a plurality of attributes. The document stored in the document storage unit 100 includes an attribute name and an attribute value in association with each attribute of the document.

An attribute name is the name of an attribute that the document has in accordance with the type of the document. An attribute value is the value of an attribute of the document.

FIG. 3 shows an example of the data structure of a patent document associated with a digital camera. In the example shown in FIG. 3, a document 111 includes, as the attribute names of the attributes of the document 111, a document number used to identify the document 111 as a patent document, a title and body representing the contents of the document 111, an applicant who applied for the patent concerning the contents of the document 111, and a filing date and importance of the patent.

In addition, the document 111 includes, for example, an attribute value “d01” in association with the attribute name “document number”. This indicates that the document number used to identify the document 111 is “d01”. Here, (the attribute value associated with) the attribute name “document number” has been described. For the remaining attributes as well, the document 111 includes attribute values in association with the attribute names. Note that the attribute values included in the document 111 in association with the attribute names “title” and “body” include texts each formed from a plurality of words. In the document (patent document) 111 shown in FIG. 3, for example, the abstract of the patent document or the like is included in the attribute value of the attribute having the attribute name “body”.

Although the document 111 has been described here, the document storage unit 100 stores a plurality of documents (patent documents). The documents stored in the document storage unit 100 need not have all the attributes of the above-described document 111 shown in FIG. 3 and may have another attribute.

Note that a type (attribute value type) is determined in advance for each attribute of a document, although not illustrated in FIG. 3. For example, if the attribute value of an attribute includes a text, like the attributes having the attribute names “title” and “body”, the type of the attributes having the attribute names “title” and “body” is a text type. If the attribute value of an attribute is a discontinuous value, like the attributes having the attribute names “applicant” and “patent importance”, the type of the attribute is a discrete value type. If the attribute value of an attribute is a continuous value, like the attribute having the attribute name “filing date”, the type of the attribute is a continuous value type.

FIGS. 4, 5, 6, 7, 8, and 9 are views showing examples of the data structure of category information stored in the category storage unit 110 shown in FIG. 2. Each category information stored in the category storage unit 110 represents a category into which documents stored in the document storage unit 100 are classified. Note that the categories represented by the category information stored in the category storage unit 110 form, for example, a hierarchical structure. Note that in this embodiment, the categories into which the documents stored in the document storage unit 100 are classified are created in advance, and pieces of category information representing the categories are stored in the category storage unit 110. The categories may be created by, for example, clustering the plurality of documents stored in the document storage unit 100.

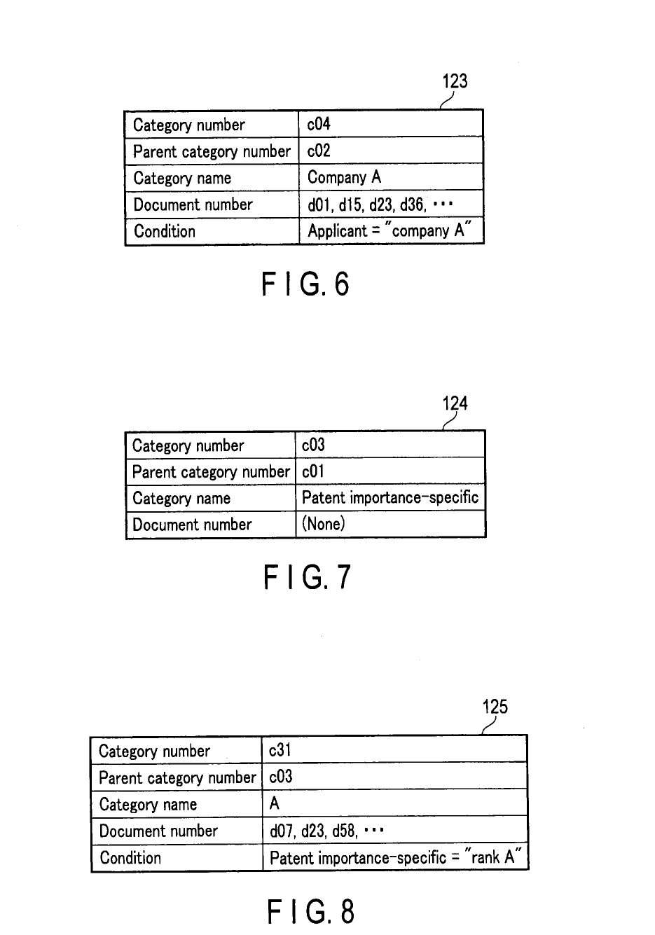

As shown in FIGS. 4, 5, 6, 7, 8, and 9, each category information includes a category number, a parent category number, a category name, and a document number. Note that the category information may include a condition as needed, as shown in FIGS. 6, 8, and 9.

The category number is an identifier used to uniquely identify a category. The parent category number is a category number used to identify a category (parent category) located on a level immediately above the category identified by the category number in the hierarchical structure. The category name is the name of the category identified by the category number. The document number is a document number used to identify a document classified into the category identified by the category number. The condition is a condition that the document classified into the category identified by the category number should meet.

Note that the category information stored in the category storage unit 110 represents, for example, a category on the basis of an attribute name or attribute value included in the documents stored in the document storage unit 100 (that is, a category corresponding to an attribute name or attribute value).

FIG. 4 shows an example of the data structure of category information representing the category of the root (to be referred to as a root category hereinafter) in the hierarchical structure of categories.

In the example shown in FIG. 4, category information 121 includes a category number “c01”, a parent category number “(none)”, a category name “(root)”, and a document number “(none)”. The category information 121 indicates that the category name of the root category identified by the category number “c01” is “(root)”. Note that the parent category “(none)” indicates that no parent category exists for the category (root category) identified by the category number “c01” in the hierarchical structure. In addition, the document number “(none)” indicates that no document is classified into the root category identified by the category number “c01”. Note that this also applies to the document number “(none)” included in the category information to be described below, and a description thereof will be omitted.

FIG. 5 shows an example of the data structure of category information representing a category subordinate to the root category in the hierarchical structure of categories.

In the example shown in FIG. 5, category information 122 includes a category number “c02”, a parent category number “c01”, a category name “applicant-specific”, and a document number “(none)”. The category information 122 indicates that the parent category of the category identified by the category number “c02” is the category identified by the parent category number “c01” (that is, root category). The category information 122 also indicates that the category name of the category identified by the category number “c02” is “applicant-specific”.

Note that the category information 122 shown in FIG. 5 represents the category corresponding to the attribute name “applicant” included in the documents stored in the document storage unit 100.

FIG. 6 shows an example of the data structure of category information representing a category subordinate to the category represented by the category information 122 shown in FIG. 5 in the hierarchical structure of categories.

In the example shown in FIG. 6, category information 123 includes a category number “c21”, a parent category number “c02”, a category name “company A”, document numbers “d01, d15, d23, d36, . . . ”, and a condition “applicant=company A”. The category information 123 indicates that the parent category of the category identified by the category number “c21” is the category identified by the parent category number “c02” (that is, the category represented by the category information 122 shown in FIG. 5). The category information 123 also indicates that the category name of the category identified by the category number “c21” is “company A”. The category information 123 also indicates that documents that meets the condition “applicant=company A”, that is, documents identified by the document numbers “d01”, “d15”, “d23”, “d36”, and the like are classified into the category identified by the category number “c21”. Note that the condition “applicant=company A” indicates that the documents include “company A” as the attribute value of the attribute name “applicant”.

Note that the category information 123 shown in FIG. 6 represents the category corresponding to the attribute value “company A” included in the documents stored in the document storage unit 100. That is, the category represented by the category information 123 shown in FIG. 6 is the category into which documents (patent documents) having company A as the applicant are classified.

FIG. 7 shows an example of the data structure of category information representing a category subordinate to the root category in the hierarchical structure of categories.

In the example shown in FIG. 7, category information 124 includes a category number “c03”, a parent category number “c01”, a category name “patent importance-specific”, and a document number “(none)”. The category information 124 indicates that the parent category of the category identified by the category number “c03” is the category identified by the parent category number “c01” (that is, root category). The category information 124 also indicates that the category name of the category identified by the category number “c03” is “patent importance-specific”.

Note that the category information 124 shown in FIG. 7 represents the category corresponding to the attribute name “patent importance” included in the documents stored in the document storage unit 100.

FIG. 8 shows an example of the data structure of category information representing a category subordinate to the category represented by the category information 124 shown in FIG. 7 in the hierarchical structure of categories.

In the example shown in FIG. 8, category information 125 includes a category number “c31”, a parent category number “c03”, a category name “A”, document numbers “d07, d23, d58, . . . ”, and a condition “patent importance=“rank A””. The category information 125 indicates that the parent category of the category identified by the category number “c31” is the category identified by the parent category number “c03” (that is, the category represented by the category information 124 shown in FIG. 7). The category information 125 also indicates that the category name of the category identified by the category number “c31” is “A”. The category information 125 also indicates that documents that meets the condition “patent importance=“rank A””, that is, documents identified by the document numbers “d07”, “d23”, “d58”, and the like are classified into the category identified by the category number “c31”. Note that the condition “patent importance=“rank A”” indicates that the documents include “rank A” as the attribute value of the attribute name “patent importance”.

Note that the category information 125 shown in FIG. 8 represents the category corresponding to the attribute value “rank A” included in the documents stored in the document storage unit 100. That is, the category represented by the category information 125 shown in FIG. 8 is the category into which documents (patent documents) for which the patent importance is set to rank A are classified.

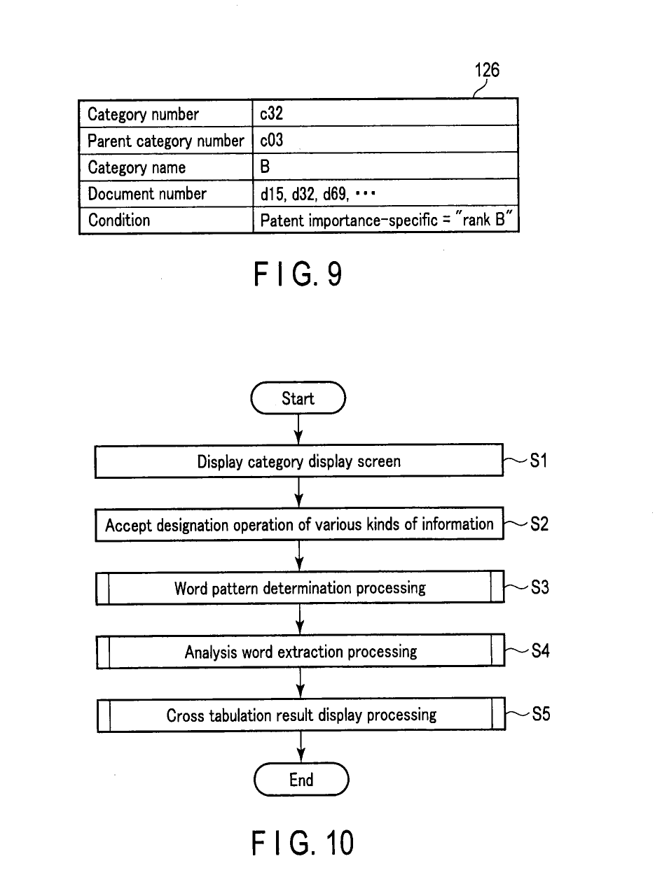

FIG. 9 shows an example of the data structure of category information representing a category subordinate to the category represented by the category information 124 shown in FIG. 7 in the hierarchical structure of categories.

In the example shown in FIG. 9, category information 126 includes a category number “c32”, a parent category number “c03”, a category name “B”, document numbers “d15, d32, d69, . . . ”, and a condition “patent importance=“rank B””. The category information 126 indicates that the parent category of the category identified by the category number “c32” is the category identified by the parent category number “c03” (that is, the category represented by the category information 124 shown in FIG. 7). The category information 126 also indicates that the category name of the category identified by the category number “c32” is “B”. The category information 126 also indicates that documents that meets the condition “patent importance=“rank B””, that is, documents identified by the document numbers “d15”, “d32”, “d69”, and the like are classified into the category identified by the category number “c32”. Note that the condition “patent importance=“rank B”” indicates that the documents include “rank B” as the attribute value of the attribute name “patent importance”.

Note that the category information 126 shown in FIG. 9 represents the category corresponding to the attribute value “rank B” included in the documents stored in the document storage unit 100. That is, the category represented by the category information 126 shown in FIG. 9 is the category into which documents (patent documents) for which the patent importance is set to rank B are classified.

The processing procedure of the document analysis apparatus 10 according to this embodiment will be described next with reference to the flowchart of FIG. 10.

First, the category display operation unit 131 included in the user interface unit 130 of the document analysis apparatus 10 displays a category display screen to present the categories that form the hierarchical structure to the user based on the category information stored in the category storage unit 110 (step S1). In this case, the categories that form the hierarchical structure are displayed based on the category numbers, category names, and parent category numbers included in the category information stored in the category storage unit 110.

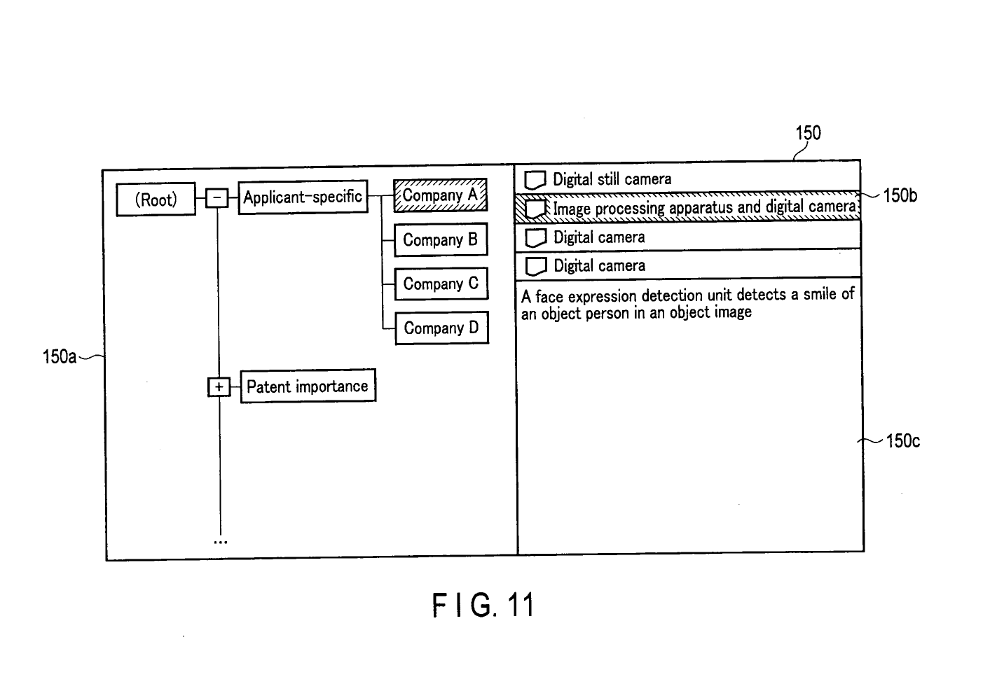

FIG. 11 shows an example of the category display screen. A category display screen 150 shown in FIG. 11 is provided with a category display region 150a, a title display region 150b, and a body display region 150c. The category display region 150a displays, by a hierarchical structure, (the category names of) of the categories represented by the category information stored in the category storage unit 110. In the example shown in FIG. 11, for example, the “applicant-specific” category and the “patent importance” category are displayed in the category display region 150a as the child categories of the root category (categories located on a level immediately under the root category). In addition, the “company A” category, a “company B” category, a “company C” category, and a “company D” category are displayed in the category display region 150a as the child categories of the “applicant-specific” category (categories located on a level immediately under the “applicant-specific” category). For example, the “applicant-specific” category displayed in the category display region 150a is the category whose category name is “applicant-specific”, and this also applies to the remaining categories. The same expression will be made in the following description.

Note that the “applicant-specific” category and the “patent importance” category out of the categories displayed in the category display region 150a shown in FIG. 11 are categories corresponding to the attribute names “applicant” and “patent importance” included in the documents stored in the document storage unit 100. The “company A” category, the “company B” category, the “company C” category, and the “company D” category are categories corresponding to the attribute values “company A”, “company B”, “company C”, and “company D” of attributes having the attribute name “applicant”.

Although not displayed in the category display region 150a shown in FIG. 11, if the user designates, for example, the “patent importance” category in the category display region 150a, the categories corresponding to the attribute values “rank A”, “rank B”, and the like of attributes having the attribute name “patent importance” (that is, the child categories of the “patent importance” category) are displayed. Note that the “applicant-specific” category, the “patent importance” category, and the like are displayed in the category display region 150a for the sake of convenience. Categories corresponding to other attributes (for example, the attribute having the attribute name “filing date”) are displayed in the same way.

The user can select, for example, one of the categories displayed in the category display region 150a. The title display region 150b displays the list of titles (attribute values for the attribute name “title” included in the documents) of the documents classified into the category selected by the user out of the categories displayed in the category display region 150a. In the example shown in FIG. 11, the “company A” category is selected out of the categories displayed in the category display region 150a, and the list of titles of documents classified into the “company A” category is displayed in the title display region 150b. More specifically, “electronic still camera”, “image processing apparatus and digital camera”, “digital camera”, and “digital camera” are displayed in the title display region 150b as the titles of the documents classified into the “company A” category.

The user can select, for example, one title from the list of document titles displayed in the title display region 150b. The body display region 150c displays the body (the attribute value of the attribute having the attribute name “body”) of the document having the title selected by the user out of the list of document titles displayed in the title display region 150b. In the example shown in FIG. 11, “image processing apparatus and digital camera” is selected from the list of document titles displayed in the title display region 150b, and the body “A face expression detection unit detects a smile of an object person in an object image.” of the document having the title “image processing apparatus and digital camera” is displayed in the body display region 150c.

Referring back to FIG. 10, the user can perform an operation of designating various kinds of information via a category display screen (screen as shown in FIG. 11) displayed by the category display operation unit 131. More specifically, the user performs an operation of a plurality of documents (to be referred to as analysis target documents hereinafter) to be analyzed by the document analysis apparatus 10, a text of the analysis target documents, two attributes whose trends are to be analyzed in combination with the text, a pattern representing the presence/absence of a correlation between a word and each of the two attributes, and the number of words (to be referred to as an extracted word count hereinafter) to be extracted based on the pattern.

When the user performs the above-described operation of designating various kinds of information, the category display operation unit 131 accepts the designation operation of the user (step S2).

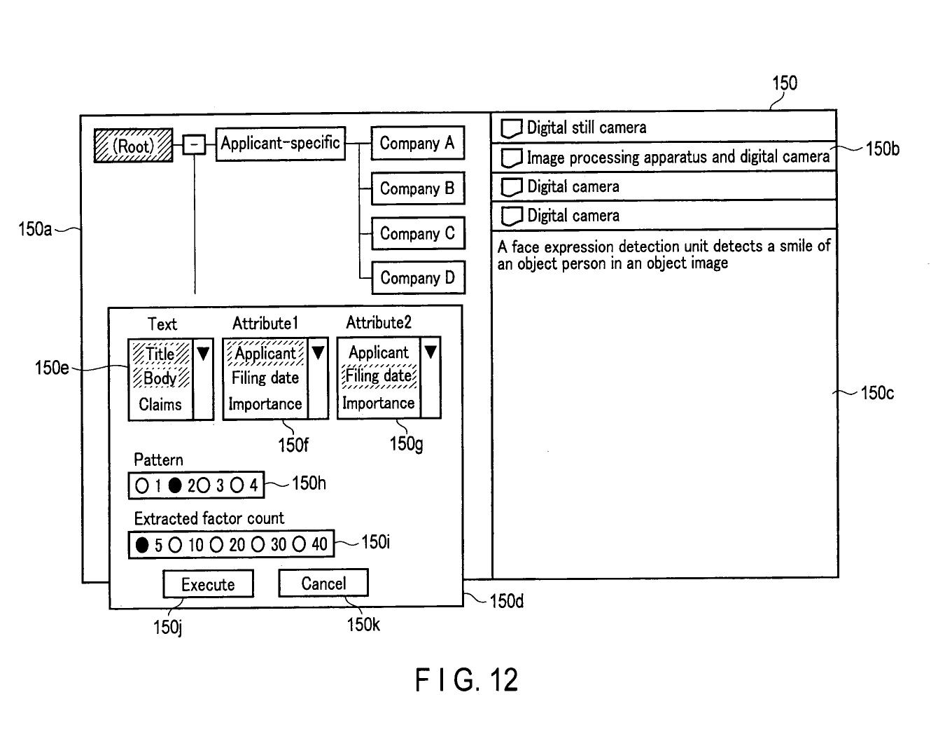

The screen displayed when the user designates various kinds of information will be described with reference to FIG. 12. In this case, the user can designate analysis target documents by designating a category displayed in the category display region 150a of the category display screen 150. Note that when, for example, the root category is designated, as shown in FIG. 12, the analysis target documents include documents classified into all categories subordinate to the root category.

When the user designates various kinds of information, a designation operation screen 150d is displayed in the category display screen 150, as shown in FIG. 12. The designation operation screen 150d is provided with a text designation field 150e, an attribute 1 designation field 150f, an attribute 2 designation field 150g, a pattern designation field 150h, an extracted word count designation field 150i, an execution button 150j, and a cancel button 150k.

In the text designation field 150e, the user can designate a text to extract a word. The attribute names (here, “title” and “body”) of attributes of the analysis target documents, which correspond to attribute values including texts, are displayed in the text designation field 150e, and at least one of the attribute names can be selected. In the example shown in FIG. 12, “title” and “body” are designated as texts to extract a word. In this case, texts included in the attribute values of the attributes having the attribute names “title” and “body” are designated.

In the attribute 1 designation field 150f and the attribute 2 designation field 150g, the user can designate two attributes whose trends are to be analyzed in combination with the texts (texts in the analysis target documents) designated in the text designation field 150e. Out of the attribute names of the attributes of the analysis target documents, attribute names (here, “applicant”, “filing date”, and “patent importance”) other than document numbers and the attribute names displayed in the above-described text designation field 150e are displayed in the attribute 1 designation field 150f and the attribute 2 designation field 150g. The user can select one of the attribute names in each field. Note that, for example, an attribute (to be referred to as a discrete value attribute hereinafter) whose type is the discrete value type is selected in the attribute 1 designation field 150f. On the other hand, for example, an attribute (to be referred to as a continuous value attribute hereinafter) whose type is the continuous value type is selected in the attribute 2 designation field 150g. In the example shown in FIG. 12, “applicant” is designated in the attribute 1 designation field 150f, and “filing date” is designated in the attribute 2 designation field 150g. The attribute designated in the attribute 1 designation field 150f will be referred to as a first attribute, and the attribute designated in the attribute 2 designation field 150g as a second attribute hereinafter. Note that an explanation has been made here assuming that a discrete value attribute is designated as the first attribute, and a continuous value attribute is designated as the second attribute. However, for example, discrete value attributes may be designated as the first and second attributes, or continuous value attributes may be designated as the first and second attributes.

In the pattern designation field 150h, the user can designate, from a plurality of patterns stored in the above-described pattern storage unit 120, a pattern (pattern representing the presence/absence of a correlation between a word and each of the first attribute and the second attribute) in which the user wants to obtain a finding.

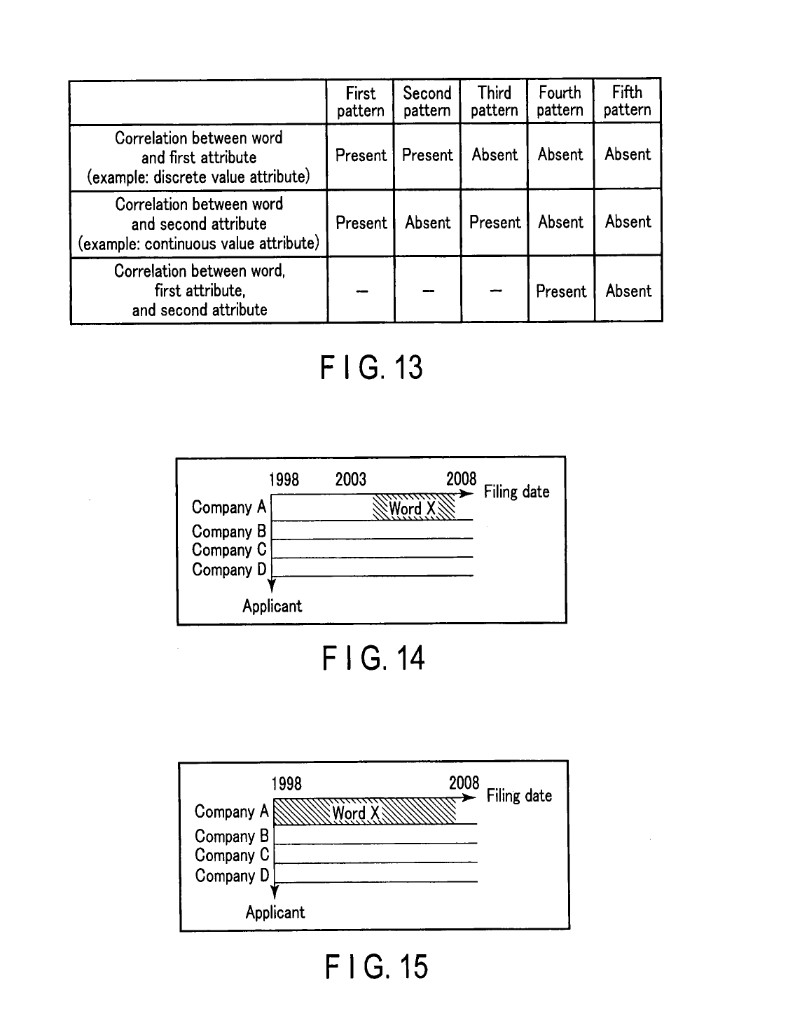

Patterns that can be designated in the pattern designation field 150h (that is, the plurality of patterns stored in the pattern storage unit 120) will be described here with reference to FIG. 13.

As shown in FIG. 13, the patterns representing the presence/absence of a correlation between a word and each of the first attribute and the second attribute include first to fifth patterns. Each of the first to fifth patterns will be described below.

The first pattern is a pattern representing that a word and the first attribute (for example, discrete value attribute) have a correlation, and the word and the second attribute (for example, continuous value attribute) have a correlation. Note that a word that has a correlation with the first attribute and a correlation with the second attribute will be referred to as a word that matches the first pattern.

The first pattern will be described here in detail with reference to FIG. 14. When, for example, the first attribute is the attribute having the attribute name “applicant” (to be referred to as an “applicant” attribute hereinafter), and the second attribute is the attribute having the attribute name “filing date” (to be referred to as a “filing date” attribute hereinafter), a word X that matches the first pattern represents a technology (contents) for which a specific applicant filed an application during a specific period.

The second pattern is a pattern representing that a word and the first attribute have a correlation, and the word and the second attribute have no correlation. Note that a word that has a correlation with the first attribute and no correlation with the second attribute will be referred to as a word that matches the second pattern.

The second pattern will be described here in detail with reference to FIG. 15. When, for example, the first attribute is the “applicant” attribute, and the second attribute is the “filing date” attribute, the word X that matches the second pattern represents a technology (contents) for which a specific applicant filed an application irrespective of the period.

The third pattern is a pattern representing that a word and the first attribute have no correlation, and the word and the second attribute have a correlation. Note that a word that has no correlation with the first attribute and a correlation with the second attribute will be referred to as a word that matches the third pattern.

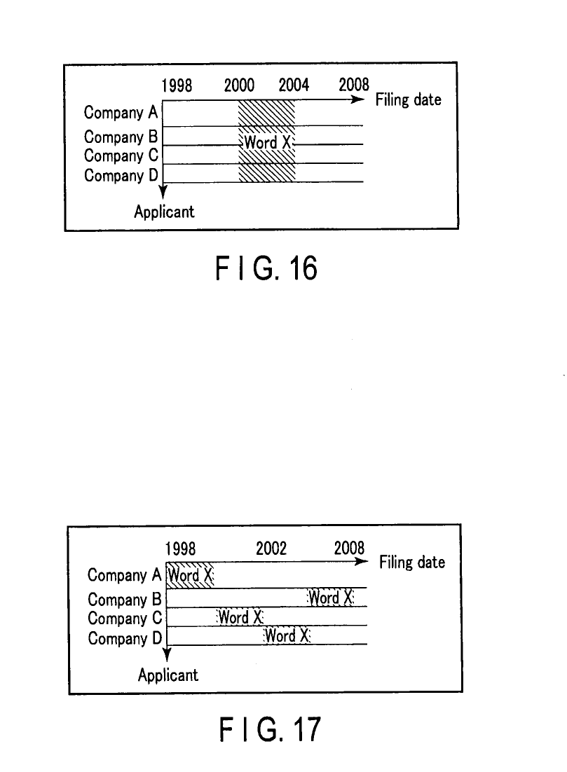

The third pattern will be described here in detail with reference to FIG. 16. When, for example, the first attribute is the “applicant” attribute, and the second attribute is the “filing date” attribute, the word X that matches the third pattern represents a technology (contents) for which each applicant filed an application during a specific period.

Note that in the above-described first to third patterns, the correlation between the word, the first attribute, and the second attribute can be either present or absent.

The fourth pattern is a pattern representing that a word and the first attribute have no correlation, the word and the second attribute have no correlation, and the word, the first attribute, and the second attribute have a correlation. Note that a word that has no correlation with the first attribute, no correlation with the second attribute, and a correlation with the first attribute and the second attribute will be referred to as a word that matches the fourth pattern.

The fourth pattern will be described here in detail with reference to FIG. 17. When, for example, the first attribute is the “applicant” attribute, and the second attribute is the “filing date” attribute, the word X that matches the fourth pattern represents a technology (contents) for which each applicant filed an application during each period.

Note that the patterns representing the presence/absence of a correlation between a word and each of the first and second attributes include a fifth pattern in addition to the above-described first to fourth patterns. The fifth pattern is a pattern representing that a word and the first attribute have no correlation, the word and the second attribute have no correlation, and the word, the first attribute, and the second attribute have no correlation. Note that since a word that has no correlation with any attribute, as in the fifth pattern, is not useful in document analysis, the fifth pattern is not designated the user, as indicated by the above-described pattern designation field 150h shown in FIG. 12. In other words, in the pattern designation field 150h, the user can designate the above-described first to fourth patterns (simply referred to as 1 to 4 in the pattern designation field 150h shown in FIG. 12). In the example shown in FIG. 12, “pattern 2 (that is, second pattern)” is designated.

Note that in the example shown in FIG. 12, the patterns are indicated by numbers. However, images (that is, images showing examples of findings obtained by the patterns) that allow the user to conceptually recognize the patterns, as shown in FIGS. 14, 15, 16, and 17, may be stored in the pattern storage unit 120 in advance and displayed.

In the extracted word count designation field 150i the user can designate the number of words (extracted word count) to be extracted as words to be represented to the user out of words that match the pattern designated by the user. For example, “5”, “10”, “20”, “30”, and “40” are displayed in the extracted word count designation field 150i as the extracted word count, and “5” is designated as the extracted word count.

After performing the designation operation in each of the above-described fields 150e to 150i, if the execution button 150j provided on the designation operation screen 150d is designated (pressed) using, for example, the mouse 13, word pattern determination processing to be described later is executed. On the other hand, if the cancel button 150k provided on the designation operation screen 150d is designated (pressed) using the mouse 13 or the like, for example, the designation operation performed in the fields 150e to 150i is disabled, and the screen returns to the category display screen shown in FIG. 11.

Referring back to FIG. 10, when the category display operation unit 131 accepts the designation operation of the user, the word pattern determination processing unit 141 included in the word extraction unit 140 executes word pattern determination processing (step S3). According to the word pattern determination processing, a word (word representing the contents of a text useful for analysis) that matches the pattern designated by the user is extracted from the plurality of words included in the text of each of the analysis target documents designated by the user. Note that details of the word pattern determination processing unit 141 will be described later.

Next, the analysis word extraction unit 142 executes analysis word extraction processing (step S4). According to the analysis word extraction processing, the words extracted by the word extraction unit 140 are weighted, and a word ranked high in the weighting result is extracted. Words as many as the extracted word count designated by the user are extracted. Note that details of analysis word extraction processing will be described later.

The cross tabulation visualization unit 132 included in the user interface unit 130 executes cross tabulation result display processing (step S5). According to the cross tabulation result display processing, a result (cross tabulation result) of cross tabulation of the category generated based on the attribute value of the first attribute designated by the user and the category generated based on the attribute value of the second attribute and the list of words extracted by the analysis word extraction unit 142 are visualized and presented (displayed), as will be described later. Note that details of cross tabulation result display processing will be described later.

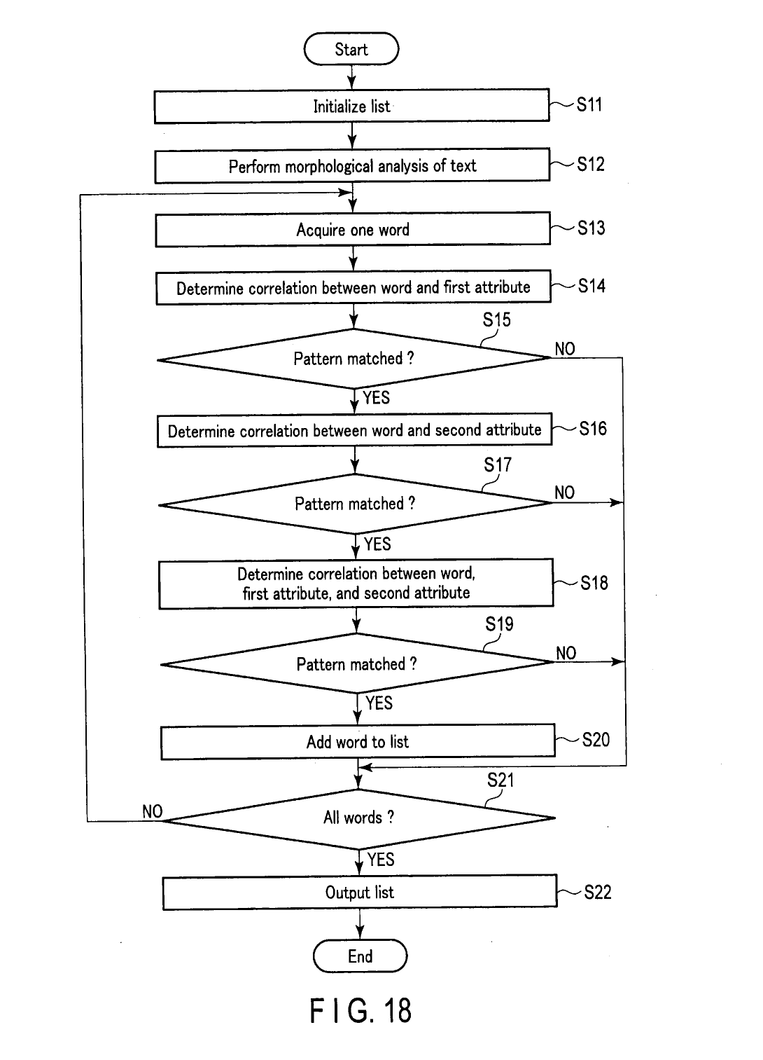

The processing procedure of the above-described word pattern determination processing (process of step S3 shown in FIG. 10) will be described next in detail with reference to the flowchart of FIG. 18. Note that the word pattern determination processing is executed by the word pattern determination processing unit 141 included in the word extraction unit 140.

A text and a pattern designated by the user via the category display screen as described above will respectively be referred to as a designated text and a designated pattern hereinafter.

First, the word pattern determination processing unit 141 initializes the list of extraction results by word pattern determination processing (step S11).

The word pattern determination processing unit 141 acquires designated texts included in (each of) analysis target documents designated by the user. For example, when title and body are designated as designated texts, texts included in the attribute values of the “title” attribute and the “body” attribute included in each of the analysis target documents are acquired. The word pattern determination processing unit 141 performs morphological analysis of the acquired designated texts (step S12). The word pattern determination processing unit 141 acquires a set of morphemes (to be referred to as words hereinafter) based on the morphological analysis result. The set of words acquired by the word pattern determination processing unit 141 includes independent words, for example, nouns, verbs, and adjectives according to parts of speech.

The processes of steps S13 to S20 to be described below are executed for each of the words acquired by the word pattern determination processing unit 141.

In this case, the word pattern determination processing unit 141 acquires one word from the set of words acquired based on the morphological analysis result (step S13). The word acquired in step S13 will be referred to as a target word hereinafter.

The word pattern determination processing unit 141 determines the correlation between the target word and the first attribute (step S14). In other words, the word pattern determination processing unit 141 determines the presence/absence of a correlation (that is, whether a correlation exists) between the target word and the first attribute.

The determination processing of the correlation between the target word and the first attribute will be described here in detail. The determination processing of the correlation between the target word and the first attribute changes depending on whether the first attribute is a discrete value attribute or a continuous value attribute. Note that whether the first attribute is a discrete value attribute or a continuous value attribute is discriminated based on the above-described type of the first attribute.

The determination processing of the correlation between the target word and the first attribute when the first attribute is a discrete value attribute (to be referred to as correlation determination processing between the target word and the discrete value attribute hereinafter) will be described first.

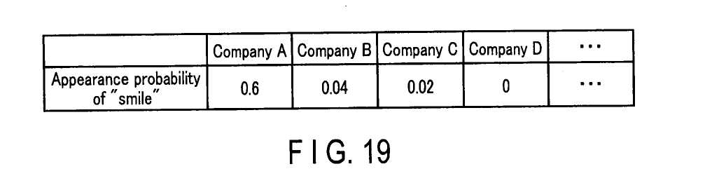

In the correlation determination processing between the target word and the discrete value attribute, it is determined, for the category of the classified discrete value attribute, whether the unevenness of appearance probability of the target word is statistically significant for a specific discrete value (that is, the attribute value of the discrete value attribute). More specifically, when the appearance probabilities of a word “smile” are compared between the applicants, as shown in FIG. 19, the appearance probability of a specific applicant (here, company A) is significantly uneven as compared to the appearance probabilities of the remaining applicants. In this case, the word “smile” is determined to have a correlation with the discrete value attribute (first attribute).

A method of determining the significance of unevenness of appearance probability between sets is variance analysis. Hence, variance analysis is used in the above-described correlation determination processing between the target word and the discrete value attribute.

The correlation determination processing between the target word and the discrete value attribute using variance analysis will be described below in detail.

Let disC1, disC2, . . . , disCa be the sets of categories of (the attribute values of) the discrete value attribute. Note that the set of categories of a discrete value attribute is a set of a plurality of categories into which analysis target documents are classified based on the attribute values of the discrete value attribute. More specifically, when the discrete value attribute is the “applicant” attribute, the set of categories of the discrete value attribute includes a category into which, out of the analysis target documents, documents including “company A” as the attribute value of the “applicant” attribute are classified, a category into which documents including “company B” as the attribute value of the “applicant” attribute are classified, a category into which documents including “company C” as the attribute value of the “applicant” attribute are classified, and the like. Note that disC1, disC2, . . . , disCa have an exclusive relationship.

Let a be the number of categories of the discrete value attribute, D be the analysis target document set, and |D| be the number of documents in the analysis target document set.

In this case, a total sum St of squares is calculated by

sₜ=df(t,D)−CT (1)

Note that in equation (1), df(t, D) is the number of documents in the analysis target document set D which include a target word t in the designated text. CT in equation (1) is defined by

$$CT = \frac{{( df ( t , D ) )}^{2}}{\vert D \vert} \qquad ( 2 )$$

Next, a sum Sa of squares between groups (sum of squares of unevenness of appearance probability for each attribute value of the discrete value attribute to the universal set) is calculated by

$${s}_{a} = {\sum }_{i = 1}^{a} ( \frac{{( df ( t , {disC}_{i} ) )}^{2}}{\vert {disC}_{i} \vert} ) - CT \qquad ( 3 )$$

Note that in equation (3), df(t, disCi) is the number of documents that include the target word t in the designated text out of the documents classified into the category disCi of the discrete value attribute. Additionally, in equation (3), |disCi| is the number of documents classified into the category disCi of the discrete value attribute.

The degree φa of freedom of the sum of squares between groups is calculated by

φₐ=a−1 (4)

A sum Se of error variations is calculated by substituting the total sum St of squares and the sum Sa of squares between groups calculated based on equations (1) and (3) described above into

sₑ=sₜ=sₐ (5)

The degree φe of freedom of the sum of error variations is calculated by

φₑ=|D|−a (6)

A variance Va between groups is calculated by substituting the sum Sa of squares between groups and the degree φa of freedom of the sum of squares between groups calculated based on equations (3) and (4) described above into

vₐ=sₐ/φₐ (7)

A variance Ve of errors is calculated by substituting the sum Se of error variations and the degree φe of freedom of the sum of error variations calculated based on equations (5) and (6) described above into

vₑ=sₑ/φₑ (8)

Finally, a variance ratio Fa is calculated by substituting the variance Va between groups and the variance Ve of errors calculated based on equations (7) and (8) described above into

Fₐ=νₐ/vₑ (9)

In the above-described correlation determination processing between the target word and the discrete value attribute, if the variance ratio Fa calculated by equation (9) is larger than the value of the F-distribution of the degree φa of freedom of the sum of squares between groups calculated by equation (4) and the degree φe of freedom of the sum of error variations calculated by equation (6), it is determined that the unevenness of the appearance probability of the target word is significant between (the categories of) the discrete value attributes, that is, there is a correlation between the target word and the discrete value attribute (first attribute). Note that the value of the F-distribution of the degree φa of freedom and the degree φe of freedom can be acquired from, for example, an F-distribution table prepared in advance in the document analysis apparatus 10 or by calculations.

The determination processing of the correlation between the target word and the first attribute when the first attribute is a continuous value attribute (to be referred to as correlation determination processing between the target word and the continuous value attribute hereinafter) will be described next.

In the correlation determination processing between the target word and the continuous value attribute, it is determined whether the appearance probability of the target word within a specific range of the continuous value is statistically significant as compared to another range of the continuous value.

Note that the attribute value (continuous value) of the continuous value attribute has no data break, unlike the attribute value (discrete value) of the above-described discrete value attribute, and the appearance probability within a specific range cannot be obtained mechanically. To do this, a histogram is used in this embodiment. The histogram is a graph created by dividing the range where the continuous value exists into several sections and counting the appearance frequency of data corresponding to each section. To draw a histogram, it is necessary to obtain the number of sections (to be referred to as a series hereinafter) and the section width (to be referred to as a class interval hereinafter). Here, the series and the class interval are obtained using, for example, the Sturges' formula.

According to the Sturges' formula, a series k is calculated by

k=1+log₂|D| (10)

Note that in equation (10), |D| is the number of analysis target documents. A class interval h is calculated, using the series k calculated based on equation (10) described above, by

$$h = \frac{( max ( cv ) - min ( cv ) )}{k} \qquad ( 11 )$$

Let cv1, cv2, . . . , cvD be the sets of categories of (the attribute values of) the continuous value attribute. In this case, max(cv) of equation (11) is the maximum value of the attribute value (that is, continuous value) of the continuous value attribute. On the other hand, min(cv) of equation (11) is the minimum value of the attribute value (that is, continuous value) of the continuous value attribute.

In the correlation determination processing between the target word and the continuous value attribute, after obtaining a histogram, as described above, the significance of unevenness of the appearance probability of a word in the class interval h calculated based on equation (11) is determined by the same processing as the above-described correlation determination processing between the target word and the discrete value attribute.

More specifically, a set of categories of the continuous value attribute (a set for each class interval h of the continuous value) is generated using the class interval h and the attribute value of the first attribute. The same processing as the above-described correlation determination processing between the target word and the discrete value attribute is executed using the generated set of categories of the continuous value attribute in place of the set of categories of the discrete value attribute. The presence/absence of a correlation between the target word and the continuous value attribute (first attribute) is thus determined. Note that the set of categories of the continuous value attribute includes, for example, a category generated for each class interval h from the minimum value of the attribute value of the continuous value attribute, into which the documents (analysis target documents) corresponding to the class interval h are classified. When the continuous value attribute is, for example, the “filing date” attribute, the document corresponding to the class interval h means a document filed during the period of the class interval h (that is, a document including a filing date corresponding to the period of the class interval h as the attribute value of the “filing date” attribute).

Note that if, for example, the “applicant” attribute is designated as the first attribute, as described above with reference to FIG. 12, the above-described correlation determination processing between the target word and the discrete value attribute is executed in step S14.

When the correlation determination processing between the target word and the first attribute is executed in the above-described way, the word pattern determination processing unit 141 determines whether the determination result (that is, whether the target word and the first attribute have a correlation) matches the designated pattern (step S15).

Assume a case where the designated pattern is the above-described second pattern (that is, a pattern representing that a word and the first attribute have a correlation, and the word and the second attribute have no correlation). The second pattern represents that the word and the first attribute have a correlation. For this reason, if the determination result in step S14 indicates that “the target word and the first attribute have a correlation”, it is determined that the determination result matches the designated pattern. On the other hand, if the determination result in step S14 indicates that “the target word and the first attribute have no correlation”, it is determined that the determination result does not match the designated pattern. Although the second pattern has been described here, this also applies to the other patterns.

Upon determining that the determination result in step S14 does not match the designated pattern (NO in step S15), the process of step S21 (to be described later) is executed.

Upon determining that the determination result in step S14 matches the designated pattern (YES in step S15), the word pattern determination processing unit 141 determines the correlation between the target word and the second attribute (step S16). Note that the determination processing of the correlation between the target word and the second attribute is the same as the process to step S14 described above, and a detailed description thereof will be omitted.

Note that if, for example, the “filing date” attribute is designated as the second attribute, as described above with reference to FIG. 12, the above-described correlation determination processing between the target word and the continuous value attribute is executed in step S16.

Next, the word pattern determination processing unit 141 determines whether the determination result in step S16 (that is, whether the target word and the second attribute have a correlation) matches the designated pattern (step S17).

Assume a case where the designated pattern is the second pattern (that is, a pattern representing that a word and the first attribute have a correlation, and the word and the second attribute have no correlation), as described above. The second pattern represents that the word and the second attribute have no correlation. For this reason, if the determination result in step S16 indicates that “the target word and the second attribute have a correlation”, it is determined that the determination result does not match the designated pattern. On the other hand, if the determination result in step S16 indicates that “the target word and the second attribute have no correlation”, it is determined that the determination result matches the designated pattern.

Upon determining that the determination result in step S16 does not match the designated pattern (NO in step S17), the process of step S21 (to be described later) is executed.

Upon determining that the determination result in step S16 matches the designated pattern (YES in step S17), the word pattern determination processing unit 141 determines whether the target word unevenly appears by the first attribute and the second attribute, that is, determines the correlation between the target word, the first attribute, and the second attribute (step S18). In other words, the word pattern determination processing unit 141 determines the presence/absence of a correlation (that is, whether a correlation exists) between the target word, the first attribute, and the second attribute.

The determination processing of the correlation between the target word, the first attribute, and the second attribute will be described here in detail.

In the determination processing of the correlation between the target word, the first attribute, and the second attribute, it is determined whether the unevenness of appearance probability of the target word is statistically significant in document sets that combine the attribute values (for example, discrete values) of the first attribute and the attribute values (for example, continuous values) of the second attribute (document sets including each of the attribute values of the first attribute and each of the attribute values of the second attribute).

A method of determining unevenness by combining two attributes is two way analysis of variance. Hence, two way analysis of variance is used in the above-described determination processing of the correlation between the target word, the first attribute, and the second attribute.

The determination processing of the correlation between the target word, the first attribute, and the second attribute using two way analysis of variance will be described below in detail. A description will be made here assuming that the first attribute is a discrete value attribute, and the second attribute is a continuous value attribute.

Note that let disC1, disC2, . . . , disCa be the sets of categories of the above-described discrete value attribute (first attribute), and a be the number of categories of the discrete value attribute. Let conC1, conC2, . . . , conCb be the sets of categories (sets for the class intervals of the continuous value) of the above-described continuous value attribute (second attribute), and b be the number of categories of the continuous value attribute. Also let D be the analysis target document set, and |D| be the number of documents in the analysis target document set.

In this case, the total sum St of squares is calculated by

sₜ=df(t,D)−CT (12)

Note that in equation (12), df(t, D) is the number of documents in the analysis target document set D which include the target word t in the designated text. CT in equation (12) is defined by

$$CT = \frac{{( df ( t , D ) )}^{2}}{\vert abn \vert} \qquad ( 13 )$$

n in equation (13) is defend by

$$n = \frac{\vert D \vert}{\vert \sqrt{ab} \vert} \qquad ( 14 )$$

Next, the sum Sa of squares between discrete values is calculated by

$${s}_{a} = {\sum }_{i = 1}^{a} ( \frac{{( df ( t , {disC}_{i} ) )}^{2}}{\vert {disC}_{i} \vert} ) - CT \qquad ( 15 )$$

Note that in equation (15), df(t, disCi) is the number of documents that include the target word t in the designated text out of the documents classified into the category disCi of the discrete value attribute. Additionally, in equation (15), |disCi| is the number of documents classified into the category disCi of the discrete value attribute.

A sum Sb of squares between class intervals of the continuous value is calculated by

$${s}_{b} = {\sum }_{i = 1}^{b} ( \frac{{( df ( t , {conC}_{i} ) )}^{2}}{\vert {conC}_{i} \vert} ) - CT \qquad ( 16 )$$

Note that in equation (16), df(t, conCi) is the number of documents that include the target word t in the designated text out of the documents classified into the category conCi of the continuous value attribute. Additionally, in equation (16), |conCi| is the number of documents classified into the category conCi of the continuous value attribute.

A sum Sab of squares between sets that combine the discrete values and the class intervals of the continuous value is calculated by

$${s}_{ab} = {\sum }_{i = 1}^{a} {\sum }_{j = 1}^{b} ( \frac{{( df ( t , ( {disC}_{i} , {conC}_{j} ) ) )}^{2}}{\vert {disC}_{i} ⋀ {conC}_{j} \vert} ) - CT \qquad ( 17 )$$

Note that in equation (17), df(t, (disCi, conCi)) is the number of documents that include the target word t in the designated text out of the documents classified into both the category disCi of the discrete value attribute and the category conCi of the continuous value attribute. Additionally, in equation (17), |disCîconCi| is the number of documents classified into both the category disCi of the discrete value attribute and the category conCi of the continuous value attribute.

The degree φab of freedom of the sum of squares between sets that combine the discrete values and the class intervals of the continuous value is calculated by

φ_{ab}=(a−1)(b−1) (18)

Note that (a−1) in equation (18) represents the above-described degree φa of freedom of the sum of squares between discrete values, and (b−1) represents the above-described degree φb of freedom of the sum of squares between class intervals of the continuous value.

The sum Se of error variations is calculated by substituting the total sum St of squares calculated based on equation (12), the sum Sa of squares between discrete values calculated based on equation (15), the sum Sb of squares between class intervals of the continuous value calculated based on equation (16), and the sum Sab of squares between sets that combine the discrete values and the class intervals of the continuous value, which is calculated based on equation (17) described above into

sₑ=sₜ−sₐ−s_{b}−s_{ab} (19)

The degree φe of freedom of the sum of error variations is calculated by

φₑab(n−1) (20)

A variance Vab between groups is calculated by substituting the sum Sab of squares between sets that combine the discrete values and the class intervals of the continuous value and the degree φab of freedom calculated based on equations (17) and (18) described above into

v_{ab}=s_{ab}/φ_{ab} (21)

The variance Ve of errors is calculated by substituting the sum Se of error variations and the degree φe of freedom calculated based on equations (19) and (20) described above into

vₑ=sₑ/φₑ (22)

Finally, a variance ratio Fab is calculated by substituting the variance Vab between groups and the variance Ve of errors calculated based on equations (20) and (21) described above into

F_{ab}=V_{ab}/Vₑ (23)

In the above-described determination processing of the correlation between the target word, the first attribute (discrete value attribute), and the second attribute (continuous value attribute) using two way analysis of variance, if the variance ratio Fab calculated by equation (23) is larger than the value of the F-distribution of the degree φab of freedom calculated by equation (18) and the degree φe of freedom calculated by equation (20), it is determined that the unevenness of the appearance probability of the word is significant between the sets that combine the first attribute (discrete values) and the second attribute (the class intervals of the continuous value), that is, there is a correlation between the target word, the first attribute, and the second attribute. Note that the value of the F-distribution of the degree φab of freedom and the degree φe of freedom can be acquired from, for example, an F-distribution table prepared in advance in the document analysis apparatus 10 or by calculations.

When the above-described determination processing of the correlation between the target word, the first attribute, and the second attribute is executed, the word pattern determination processing unit 141 determines whether the determination result (that is, whether the target word, the first attribute, and the second attribute have a correlation) matches the designated pattern (step S19).

Assume a case where the designated pattern is the above-described fourth pattern (that is, a pattern representing that a word and the first attribute have no correlation, the word and the second attribute have no correlation, and the word, the first attribute, and the second attribute have a correlation). The fourth pattern represents that the word, the first attribute, and the second attribute have a correlation. For this reason, if the determination result in step S18 indicates that “the target word, the first attribute, and the second attribute have a correlation”, it is determined that the determination result matches the designated pattern. On the other hand, if the determination result in step S18 indicates that “the target word, the first attribute, and the second attribute have no correlation”, it is determined that the determination result does not match the designated pattern.

Note that the fourth pattern has been described here. In the first to third patterns, the correlation between the word, the first attribute, and the second attribute can be either present or absent, as described above. Hence, if the designated pattern is one of the first to third patterns, it may be determined independently of the determination result of step S18 that the determination result matches the designated pattern. For example, the processes of steps S18 and S19 may be omitted. When the processes of steps S18 and S19 are omitted, the process of step S20 (to be described later) is executed after determining that the determination result matches the designated pattern in step S17.

Upon determining that the determination result in step S18 does not match the designated pattern (NO in step S19), the process of step S21 (to be described later) is executed.

Upon determining that the determination result in step S18 matches the designated pattern (YES in step S19), the word pattern determination processing unit 141 adds (registers) the target word to the list (step S20). Note that the word added to the list here is a word whose correlation with each of the first and second attributes matches the designated pattern.

The word pattern determination processing unit 141 determines whether the processes of steps S13 to S20 described above have been executed for all words (words acquired by morphological analysis of the designated text included in the analysis target documents) acquired by the word pattern determination processing unit 141 (step S21).

Upon determining that the processes have not been executed for all words (NO in step S21), the process returns to step S13 described above to repeat the processing.

Upon determining that the processes have been executed for all words (YES in step S21), the word pattern determination processing unit 141 outputs the list to the analysis word extraction unit 142 (step S22).

As described above, in the word pattern determination processing, a set of words that match the designated pattern is extracted from a plurality of words acquired by morphological analysis of the designated text included in the analysis target documents. More specifically, for example, when the designated pattern is the above-described second pattern, words that have a correlation with the first attribute (“applicant” attribute that is a discrete value attribute) but have no correlation with the second attribute (“filing date” attribute that is a continuous value attribute) are extracted.

Note that in the above-described word pattern determination processing, the correlation with the first attribute, the correlation with the second attribute, and the correlation with the first attribute and the second attribute are individually determined. This obviates the necessity of executing subsequent determination processing for the target word if, for example, the determination result of the correlation with the first attribute does not match the designated pattern. For this reason, according to the word pattern determination processing of this embodiment, it is possible to speed up the processing as compared to a case where after determining all correlations, whether the results match the designated pattern is determined.

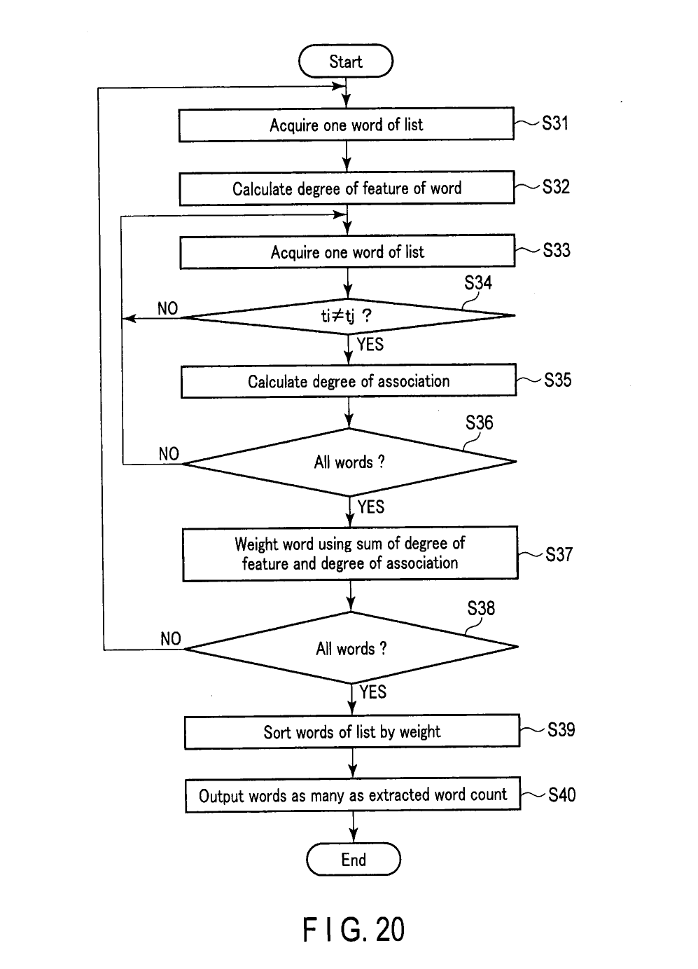

The processing procedure of the above-described analysis word extraction processing (the process of step S4 shown in FIG. 10) will be described next in detail with reference to the flowchart of FIG. 20. Note that the analysis word extraction processing is executed by the analysis word extraction unit 142 included in the word extraction unit 140.

In the analysis word extraction processing, the analysis word extraction unit 142 executes the processes of steps S31 to S37 to be described below for each of the words registered in the list (to be referred to as an analysis word list hereinafter) output by the word pattern determination processing unit 141.

In this case, the analysis word extraction unit 142 acquires one word registered in the analysis word list (step S31). Assuming below that n words are registered in the analysis word list, the word acquired in step S31 will be referred to as a word ti (i=1, 2, . . . n) hereinafter.

Based on the appearance frequency of the word ti in the designated text of the analysis target documents, the analysis word extraction unit 142 calculates the degree of feature of the word ti representing the contents of the designated text (step S32).

The calculation processing of the degree of feature of the word ti will be described here in detail. The degree of feature of the word ti is calculated by, for example, TF-IDF. TF-IDF is a representative method for extracting a word representing the contents of a text, and regards a word that frequently appears in a document but does not so frequently appear in the whole document set as a feature word. TF-IDF is calculated by various expressions. As a representative expression, the degree of feature of the word ti using TF-IDF is calculated by

tfidf(ti)=tf(ti)·idf(ti) (24)

Note that tf(ti) in equation (24) is defined by

$$tf ( ti ) = log ( \frac{tf ( ti , D )}{df ( ti , D )} + 1 ) \qquad ( 25 )$$

tf(ti, D) in equation (25) is the number of words ti included in the designated text of the analysis target document set D. In addition, df(ti, D) is the number of documents in the analysis target document set D which include the word ti in the designated text.

idf(ti) in equation (24) is defined by

$$idf ( ti ) = log ( \frac{\vert D \vert}{df ( ti , D )} ) \qquad ( 26 )$$

Note that |D| in equation (25) is the number of documents in the analysis target document set D.

Next, the analysis word extraction unit 142 executes the processes of steps S33 to S35 to be described below for each of the words registered in the analysis word list.

In this case, the analysis word extraction unit 142 acquires one word registered in the analysis word list (step S33). The word acquired in step S33 will be referred to as a word tj (j=1, 2, . . . n) hereinafter.

The analysis word extraction unit 142 determines whether the above-described word ti and word tj are different (that is, ti≠tj) (step S34).

Upon determining that the word ti and the word tj are not different (that is, the word ti and the word tj are identical) (NO in step S34), the process of step S35 is not executed, and the process of step S36 (to be described later) is executed.

Upon determining that the word ti and the word tj are different (YES in step S34), the analysis word extraction unit 142 calculates the degree of association based on the cooccurrence of the word ti and the word tj (step S35).

Note that the degree of association based on the cooccurrence of the word ti and the word tj is based on the fact that a plurality of words statistically significantly appear while cooccurring with each other, and a word that cooccurs with other words little is a word representing the contents of the designated text in the analysis target document set. Any method using the cooccurrence of words is usable without any particular limitation, and for example, mutual information, Dice coefficient, self mutual information, or the like is usable. In this embodiment, case where mutual information is used will be described.

The designated text is expressed by a plurality of words, and the cooccurrence of words that match the same pattern is considered as meaningful. Hence, in this embodiment, the word as the cooccurrence target of the word ti (that is, the word to calculate the degree of association based on the cooccurrence with the word ti) is a word that matches the same pattern as the word ti, that is, a word (word tj) registered in the analysis word list, as described above.

The calculation processing of the degree of association (mutual information) based on the cooccurrence of the word ti and the word tj will be described below in detail.

In the calculation processing of the degree of association based on the cooccurrence of the word ti and the word tj, it is determined by the χ-square test whether the cooccurrence frequency of the word tj with the word ti is statistically significant. In the calculation processing of the degree of association based on the cooccurrence of the word ti and the word tj, the degree of association is calculated only for the word tj whose cooccurrence frequency with the word ti is determined by the χ-square test to be statistically significant. That is, the degree of association is not calculated for the word tj whose cooccurrence frequency with the word ti is determined by the χ-square test not to be statistically significant.

According to the χ-square test, if the value of the χ-square distribution on a significant level of, for example, 0.5% is larger than 7.88, it is determined that the cooccurrence frequency is statistically significant. The χ-square value used by the χ-square test is calculated by

$${x}^{2} = {( {x}_{11} - \frac{{a}_{1} {b}_{1}}{\vert D \vert} )}^{2} / \frac{{a}_{1} {b}_{1}}{\vert D \vert} + {( {x}_{12} - \frac{{a}_{1} {b}_{2}}{\vert D \vert} )}^{2} / \frac{{a}_{1} {b}_{2}}{\vert D \vert} + {( {x}_{21} - \frac{{a}_{2} {b}_{1}}{\vert D \vert} )}^{2} / \frac{{a}_{2} {b}_{1}}{\vert D \vert} + {( {x}_{22} - \frac{{a}_{2} {b}_{2}}{\vert D \vert} )}^{2} / \frac{{a}_{2} {b}_{2}}{\vert D \vert} \qquad ( 27 )$$

Note that in equation (27), a1 is df(ti, D) and represents the number of documents in the analysis target document set D which include the word ti in the designated text (that is, the frequency of the word ti in the analysis target document set D).

b1 is df(tj, D) and represents the number of documents in the analysis target document set D which include the word tj in the designated text (that is, the frequency of the word tj in the analysis target document set D).

a2 is |D|−df(ti, D) and represents the number of documents in the analysis target document set D which do not include the word ti in the designated text (that is, the frequency of documents that do not include the word ti).

b2 is |D|−df(tj, D) and represents the number of documents in the analysis target document set D which do not include the word tj in the designated text (that is, the frequency of documents that do not include the word tj).

x11 is df((ti, tj), D) and represents the number of documents in the analysis target document set D which include the word ti and the word tj in the designated text (that is, the cooccurrence frequency of the word ti and the word tj).

x12 is a1−x11 and represents the number of documents in the analysis target document set D which do not include the word ti and the word tj in a document set that include the word ti in the designated text (that is, the frequency of documents that do not include x11 in the set of the word ti).

x21 is b1−x11 and represents the number of documents in the analysis target document set D which do not include the word ti and the word tj in a document set that include the word tj in the designated text (that is, the frequency of documents that do not include x11 in the set of the word tj).

x22 is a2−x22 and represents the number of documents in the analysis target document set D which do not include the document set of x21 in a document set that do not include the word ti in the designated text (that is, the frequency of documents that do not include x21 in the set that do not include the word tj).

Upon determining by the above-described χ-square test that the word tj is statistically significant, mutual information mi(ti) of the word ti and the word tj is calculated by

$$mi ( ti ) = {\sum }_{j} ( \frac{{x}_{11}}{\vert D \vert} ( log \frac{{x}_{11} \vert D \vert}{{a}_{1} {b}_{1}} ) + \frac{{x}_{12}}{\vert D \vert} ( log \frac{{x}_{12} \vert D \vert}{{a}_{1} {b}_{2}} ) + \frac{{x}_{21}}{\vert D \vert} ( log \frac{{x}_{21} \vert D \vert}{{a}_{2} {b}_{1}} ) + \frac{{x}_{22}}{\vert D \vert} ( log \frac{{x}_{22} \vert D \vert}{{a}_{2} {b}_{2}} ) ) \qquad ( 28 )$$

The analysis word extraction unit 142 determines whether the processes of steps S33 to S35 described above have been executed for all words registered in the analysis word list (step S36).

Upon determining that the processes have not been executed for all words registered in the analysis word list (NO in step S36), the process returns to step S33 described above to repeat the processing.

Upon determining that the processes have been executed for all words registered in the analysis word list (YES in step S36), the sum of the degree of feature calculated in step S32 described above and all degrees of association calculated in step S35 (that is, the degree of association between the word and of each word tj whose cooccurrence frequency with the word ti is determined by the χ-square test to be statistically significant) is set as the weight of the word ti (step S37). Note that the degree of feature and the degrees of association are preferably normalized and then added.

The analysis word extraction unit 142 determines whether the processes of steps S31 to S37 described above have been executed for all words registered in the analysis word list (step S38).

Upon determining that the processes have not been executed for all words registered in the analysis word list (NO in step S38), the process returns to step S31 described above to repeat the processing.

Upon determining that the processes have been executed for all words registered in the analysis word list (YES in step S38), all words registered in the analysis word list have been weighted.

In this case, the analysis word extraction unit 142 sorts the words registered in the analysis word list in the order of the weights of the words (step S39).

The analysis word extraction unit 142 outputs, out of the sorted words, words having highly ranged weights to the cross tabulation visualization unit 132 included in the user interface unit 130 (step S40). In this case, the analysis word extraction unit 142 outputs words as many as the extracted word count designated by the user.

As described above, in the analysis word extraction processing, each of the words extracted by the word pattern determination processing unit 141 (words registered in the analysis word list) is weighted, and highly weighted words (that is, words useful in analysis of pattern) are extracted from the words and output. Note that the words output by the analysis word extraction unit 142 are presented to the user by the cross tabulation visualization unit 132.

That is, in this embodiment, the words extracted by the word pattern determination processing unit 141 (words determined to match the designated pattern) are presented to the user based on the feature word and the degree of association (that is, the weight of the word) calculated for each word.

Additionally, in this embodiment, the degree of association is not calculated for the word tj determined by the χ-square test not to be statistically significant, as described above. It is therefore possible to more appropriately weight the words as compared to a case where the degree of association is calculated for such a word tj.

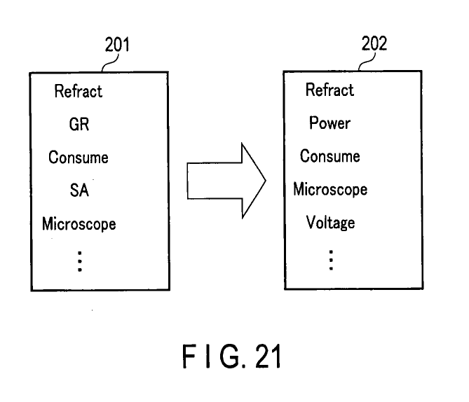

Words extracted (output) by the analysis word extraction unit 142 will be described here with reference to FIG. 21.

An analysis word list 201 shown in FIG. 21 is an analysis word list before execution of analysis word extraction processing (that is, the list output by word pattern determination processing).

As shown in FIG. 21, a plurality of words “refract”, “GR”, “consume”, “SA”, and “microscope” are registered in the analysis word list 201. In the analysis word list 201, the words are registered in the order of DF (order of the number of documents in the analysis target document set D which include the word in the designated text). Note that the words “GR” and “SA” registered in the analysis word list 201 are words that do not represent the contents of the designated text included in the analysis target documents.

On the other hand, an analysis word list 202 shown in FIG. 21 is an analysis word list after the words registered in the analysis word list 201 are sorted by the weights of the words.

As shown in FIG. 21, the words are sorted by the weights of the words registered in the analysis word list 201, and, for example, the words “refract”, “power”, “consume”, “microscope”, “voltage”, and the like are thus registered at higher ranks in the analysis word list 202. Assume that “5” is designated as the above-described extracted word count. In the analysis word extraction processing, five words “refract”, “power”, “consume”, “microscope”, and “voltage” of the highly ranked weights in the analysis word list 202 are extracted, and words such as the above-described words “GR” and “SA” that do not represent the contents of the designated text are not extracted.

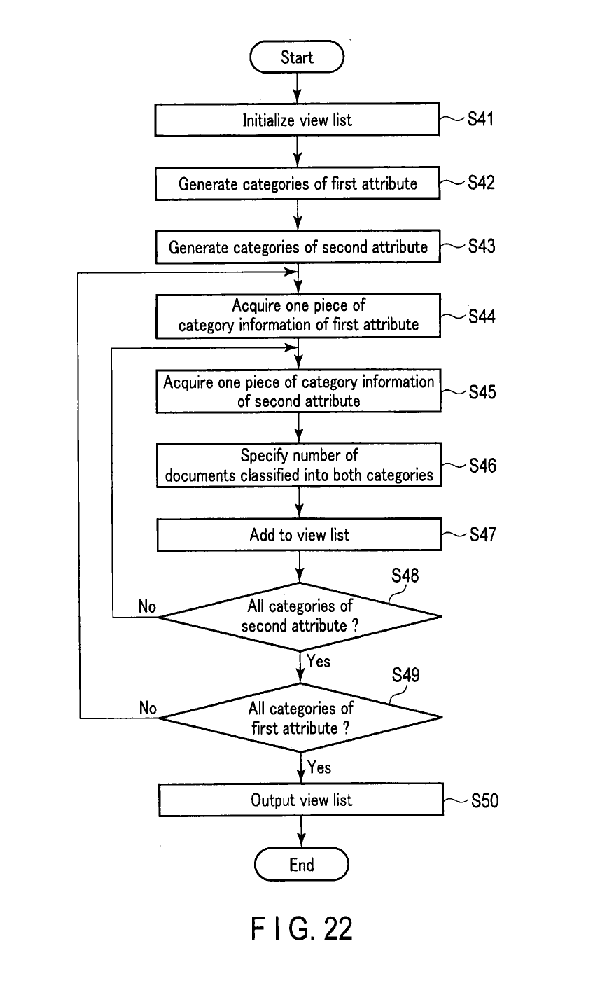

The processing procedure of the above-described cross tabulation result display processing (process of step S5 shown in FIG. 10) will be described next with reference to the flowchart of FIG. 22. Note that the cross tabulation result display processing is executed by the cross tabulation visualization unit 132 included in the user interface unit 130.

First, the cross tabulation visualization unit 132 initializes a view list that is the return value of the cross tabulation visualization unit 132 (step S41).

Based on the attribute values of the first attribute (first attribute designated by the user) included in each of the analysis target documents, the cross tabulation visualization unit 132 generates a plurality of categories (first categories) into which the analysis target documents are classified (step S42). For example, when the first attribute is the “applicant” attribute, the cross tabulation visualization unit 132 generates (a set of) categories of the above-described discrete value attribute. More specifically, the cross tabulation visualization unit 132 generates categories into which analysis target documents including, for example, “company A” as the attribute value of the “applicant” attribute are classified. Note that categories are similarly generated for the other attribute values (for example, “company B”, “company C”, and the like) of the “applicant” attribute. The categories generated in step S42 will be referred to as the categories of the first attribute hereinafter.

When the categories of the first attribute are generated by the cross tabulation visualization unit 132, as described above, category information (to be referred to as category information of the first attribute hereinafter) representing the categories of the first attribute is stored in the category storage unit 110 for each category of the first attribute. Note that the data structure of the category information of the first attribute is the same as that described above with reference to FIGS. 4, 5, 6, 7, 8, and 9, and a detailed description thereof will be omitted. That is, according to the category information of the first attribute, documents and the like classified into the categories of the first attribute can be specified.

Based on the attribute values of the second attribute (second attribute designated by the user) included in each of the analysis target documents, the cross tabulation visualization unit 132 generates a plurality of categories (second categories) into which the analysis target documents are classified (step S43). For example, when the second attribute is the “filing date” attribute, the cross tabulation visualization unit 132 generates (a set of) categories of the above-described continuous value attribute. More specifically, the class interval is calculated as described above, and a set of categories of the continuous value attribute (a set for each class interval of the continuous value) are generated using the class interval and the attribute value (that is, continuous value) of the second attribute. Note that the class interval calculation is the same as described above, and a detailed description thereof will be omitted. The categories generated in step S43 will be referred to as the categories of the second attribute hereinafter.

When the categories of the second attribute are generated by the cross tabulation visualization unit 132, as described above, category information (to be referred to as category information of the second attribute hereinafter) representing the categories of the second attribute is stored in the category storage unit 110 for each category of the second attribute. Note that the data structure of the category information of the second attribute is the same as that described above with reference to FIGS. 4, 5, 6, 7, 8, and 9, and a detailed description thereof will be omitted. That is, according to the category information of the second attribute, documents and the like classified into the categories of the second attribute can be specified.

A description has been made here assuming that the categories of the first attribute and the categories of the second attribute are generated in steps S42 and S43. For example, if the categories of the first attribute (for example, the categories of the discrete value attribute) and the categories of the second attribute (for example, the categories of the continuous value attribute) are generated, and category information representing each category is stored in the category storage unit 110 by the above-described correlation determination processing, the processes of steps S42 and S43 may be omitted.

Next, the cross tabulation visualization unit 132 executes the processes of steps S44 to S48 to be described below for each of the generated categories of the first attribute.

In this case, the cross tabulation visualization unit 132 acquires one of the pieces of category information of the first attribute from the category storage unit 110 (step S44). The category of the first attribute represented by the category information of the first attribute acquired in step S44 will be referred to as the target category of the first attribute hereinafter.

Next, the cross tabulation visualization unit 132 executes the processes of steps S45 to S47 to be described below for each of the generated categories of the second attribute.

In this case, the cross tabulation visualization unit 132 acquires one of the pieces of category information of the second attribute from the category storage unit 110 (step S45). The category of the second attribute represented by the category information of the second attribute acquired in step S45 will be referred to as the target category of the second attribute hereinafter.

Based on the category information of the first attribute acquired in step S44 and the category information of the second attribute acquired in step S45, the cross tabulation visualization unit 132 specifies a set of documents classified into both the target category of the first attribute and the target category of the second attribute (that is, a set of documents that appear in both categories).

The cross tabulation visualization unit 132 thus specifies the number of documents classified into both the target category of the first attribute and the target category of the second attribute (step S46).

The cross tabulation visualization unit 132 adds (registers) the specified number of documents to the view list in association with the target category of the first attribute and the target category of the second attribute (step S47).

The cross tabulation visualization unit 132 determines whether the processes of steps S45 to S47 described above have been executed for all the generated categories of the second attribute (step S48).

Upon determining that the processes have not been executed for all the categories of the second attribute (NO in step S48), the process returns to step S45 described above to repeat the processing.

Upon determining that the processes have been executed for all the categories of the second attribute (YES in step S48), the cross tabulation visualization unit 132 determines whether the processes of steps S44 to S48 described above have been executed for all the generated categories of the first attribute (step S49).

Upon determining that the processes have not been executed for all the categories of the first attribute (NO in step S49), the process returns to step S44 described above to repeat the processing.

Upon determining that the processes have been executed for all the categories of the first attribute (YES in step S49), the cross tabulation visualization unit 132 adds the set (list) of the words output by the analysis word extraction unit 142 to the view list and outputs the view list (step S50). Note that the contents of the view list are displayed on, for example, the display 15 as the cross tabulation result.

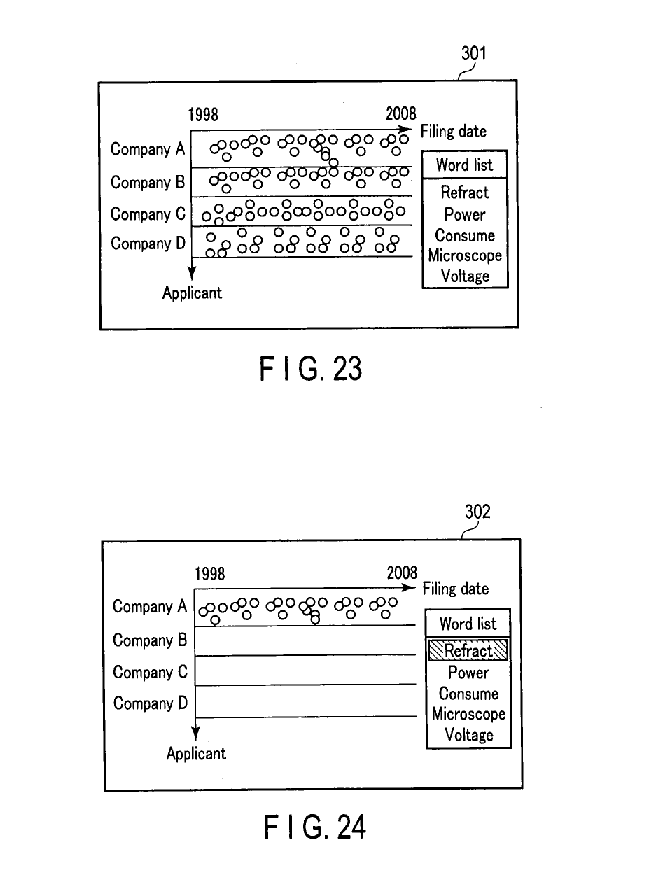

FIG. 23 shows an example of the display screen when the view list output by the cross tabulation visualization unit 132 is displayed.

The cross tabulation result and the word list are displayed on a display screen 301 shown in FIG. 23.

According to the cross tabulation result, the categories (here, “company A”, “company B”, “company C”, and “company D”) of the first attribute (for example, the “applicant” attribute that is a discrete value attribute) are plotted along the ordinate, and the second attribute (for example, the “filing date” attribute that is a continuous value attribute) is plotted along the abscissa. The number of documents (analysis target documents) classified into both the categories of the ordinate and the categories of the abscissa is indicated by ◯ in the fields where the ordinate and the abscissa cross. In this cross tabulation result, ◯ indicates one application (one document).

Note that in the cross tabulation result on the display screen 301, the boundaries of class intervals in the continuous value (that is, display of the categories of the continuous value attribute) are omitted for the sake of simplicity.

When “5” is designated as the extracted word count, as described above, five words “refract”, “power”, “consume”, “microscope”, and “voltage” extracted by the analysis word extraction unit 142 are displayed in the word list. Note that the words displayed in the word list are words that match the above-described second pattern (designated pattern).

The user can select one of the five words displayed in the word list on the display screen 301 shown in FIG. 23. Assume that in the example shown in FIG. 23, the user selects, for example, the word “refract”. A display screen 302 is then displayed, which displays the cross tabulation result in the document set narrowed down to the documents including the word “refract” in the designated text, as shown in FIG. 24. More specifically, according to the cross tabulation result on the display screen 302, the (number of) documents classified into both the categories of the ordinate (categories of the first attribute) and the categories of the abscissa (categories of the second attribute) out of the analysis target documents including the word “refract” are indicated by ◯ in the fields where the ordinate and the abscissa cross.

The number of documents (appearance of documents) is not uneven in the cross tabulation result on the display screen 301 shown in FIG. 23. However, it is easy to grasp from the cross tabulation result on the display screen 302 shown in FIG. 24 that the “company A” has applied for many patents irrespective of on a specific filing date concerning (technical contents represented by) the word “refract”. That is, in the cross tabulation result on the display screen 302 shown in FIG. 24, the finding of the second pattern representing that the word and the applicant (first attribute) have a correlation, and the word and the filing date (second attribute) have no correlation can be obtained.

A description has been made here assuming that the display screen 301 shown in FIG. 23 (and the display screen 302 shown in FIG. 24) displays the cross tabulation result and the word list. However, the display screen may display, for example, only the word list. In this case, the user searches the analysis target documents using a word displayed in the word list, thereby obtaining the finding of the pattern designated by the user, as described above.

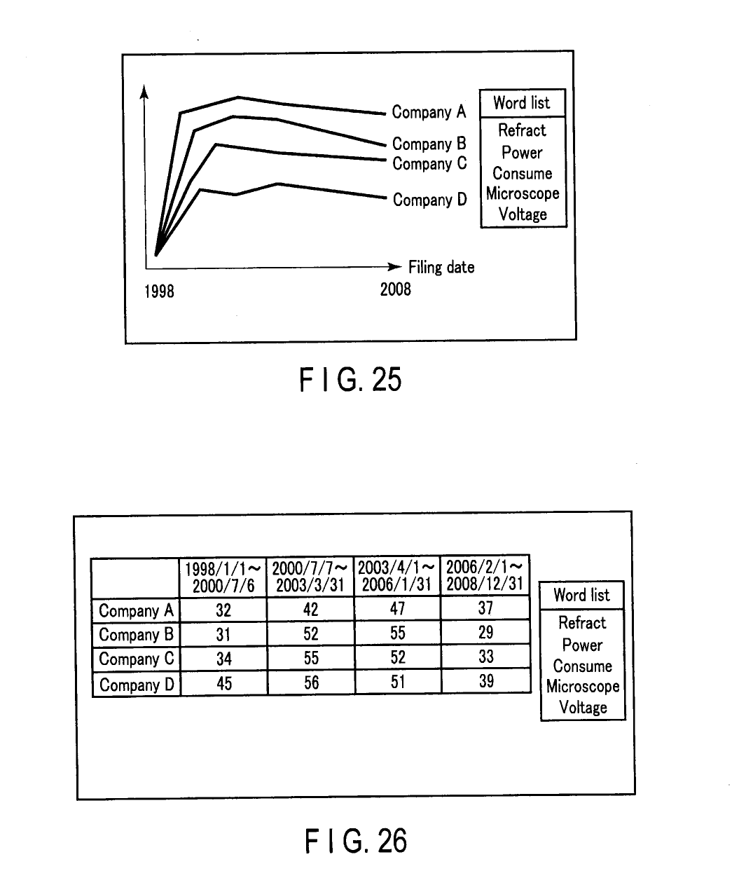

Note that in each of FIGS. 23 and 24, the cross tabulation result is displayed as a scatter diagram. However, the cross tabulation result may be displayed as a line graph, as shown in FIG. 25. Alternatively, the cross tabulation result may be displayed by numerical values, as shown in FIG. 26. Note that the cross tabulation results shown in FIGS. 23, 24, and 26 are applicable not only when the two attributes (that is, first and second attributes) designated by the user are the combination of a discrete value attribute and a continuous value attribute but also when, for example, both are discrete value attributes or both are continuous value attributes. On the other hand, the cross tabulation result shown in FIG. 25 is applicable when at least one of the two attributes designated by the user is a continuous value attribute.

As described above, in this embodiment, a plurality of words are acquired by analyzing texts included in analysis target documents, the presence/absence of a correlation between each of the acquired words and each of at least two attributes (for example, first and second attributes) designated by the user is determined, and a word whose determination result matches a pattern (designated pattern) designated by the user is presented. With this arrangement, a finding desired by the user can efficiently be obtained.

That is, in this embodiment, focusing the correlation relationship between, for example, each of two attributes and a word in texts included in analysis target documents, a word that matches a pattern designated by the user can automatically extracted from the texts. Hence, in this embodiment, when analyzing a trend by combining the texts included in the analysis target documents and two attributes, a finding according to a user's purpose can efficiently be obtained.

Additionally, in this embodiment, a word for which the presence/absence of a correlation with each of the two attributes designated by the user is determined to match a pattern designated by the user is presented based on a feature word and the degree of association (that is, the weight of the word) calculated for each word. For this reason, even when many words are determined to match the pattern, only more useful words can be presented to the user.

Note that in this embodiment, a description has mainly be made assuming that the user designates two attributes (first and second attributes). However, for example, three or more attributes may be designated.

For example, assume that the user designates three attributes (to be referred to as first to third attributes hereinafter). The user designates a pattern representing the presence/absence of a correlation between a word and each of the first to third attributes designated by the user. In the above-described word pattern determination processing, the correlation between the word and the first attribute, the correlation between the word and the second attribute, the correlation between the word and the third attribute, and the correlation between the word, the first attribute, the second attribute, and the third attribute are determined. It is then determined whether each determination result matches the pattern designated by the user.

For example, even when the user designates three attributes, it is possible to extract a word that matches the pattern designated by the user, as described in this embodiment.

Note that the method described in the above-described embodiment can be stored in a storage medium such as a magnetic disk (for example, Floppy® disk or hard disk), an optical disk (for example, CD-ROM or DVD), a magnetooptical disk (MO), or a semiconductor memory and distributed as a program executable by a computer.

The storage medium can employ any storage format as long as it can store a program and is readable by a computer.

An OS (Operating System) operating on the computer or MW (middleware) such as database management software or network software may execute part of each processing for implementing the embodiment based on the instruction of the program installed from the storage medium to the computer.

The storage medium according to the present invention is not limited to a medium independent of the computer, and also includes a storage medium that stores or temporarily stores the program transmitted by a LAN or the Internet and downloaded.

The number of storage media is not limited to one. The storage medium according to the present invention also incorporates a case where the processing of the embodiment is executed from a plurality of media, and the media can have any arrangement.

Note that the computer according to the present invention is configured to execute each processing of the embodiment based on the program stored in the storage medium, and can be either a single device formed from a personal computer or microcomputer or a system including a plurality of devices connected via a network.

The computer according to the present invention is not limited to a personal computer, and also includes an arithmetic processing device or microcomputer included in an information processing apparatus. Computer is a general term for apparatuses and devices capable of implementing the functions of the present invention by the program.

While certain embodiments of the inventions have been described, these embodiments have been presented by way of examples only, and are not intended to limit the scope of the inventions. Indeed, the embodiments may be implemented in a variety of other forms; furthermore, various omissions, substitutions and changes may be made without departing from the spirit of the inventions. The appended claims and their equivalents are intended to cover such forms or modifications as would fall within the scope and spirit of the inventions.

1. A document analysis apparatus comprising:
a document storage unit which stores a plurality of documents each of which includes a text formed from a plurality of words, has a plurality of attributes, and includes attribute values of the attributes;
a pattern storage unit which stores a plurality of patterns each representing presence/absence of a correlation between a word and each of at least two attributes out of the plurality of attributes;
an acquisition unit which acquires a plurality of words by analyzing the text included in each of the plurality of documents stored in the document storage unit;
a first determination unit which determines, for each of the acquired words, the presence/absence of the correlation between the word and at least two attributes designated by a user out of the plurality of attributes of the plurality of documents stored in the document storage unit;
a second determination unit which determines whether a determination result by the first determination unit matches a pattern designated by the user out of the plurality of patterns stored in the pattern storage unit; and
a presentation unit which presents a word whose determination result by the first determination unit is determined to match the pattern designated by the user.

2. The document analysis apparatus according to claim 1, further comprising:
a first calculation unit which calculates, for each word whose determination result is determined to match the pattern designated by the user, a degree of feature based on an appearance frequency of the word in the plurality of documents stored in the document storage unit; and
a second calculation unit which calculates, for each word whose determination result is determined to match the pattern designated by the user, a degree of association based on cooccurrence of the word in the plurality of documents stored in the document storage unit and a word other than the word, whose determination result by the first determination unit is determined to match the pattern designated by the user,
wherein the presentation unit presents the word whose determination result by the first determination unit is determined to match the pattern designated by the user, based on the degree of feature and the degree of association calculated for each word.

3. The document analysis apparatus according to claim 2, wherein the second calculation unit calculates, for each word whose determination result by the first determination unit is determined to match the pattern designated by the user, the degree of association based on cooccurrence of the word and a word whose cooccurrence frequency with the word is statistically significant.

4. The document analysis apparatus according to claim 1, further comprising a category generation unit,
wherein the at least two attributes designated by the user include a first attribute and a second attribute,
the category generation unit generates a first category into which the plurality of documents are classified based on an attribute value of the first attribute included in the plurality of documents, and generates a second category into which the plurality of documents are classified based on the attribute value of the second attribute included in the plurality of documents, and
the presentation unit further presents a cross tabulation result including the number of documents classified into both the first category and the second category, which are generated.

5. The document analysis apparatus according to claim 4, when the presented word is designated by the user, wherein the presentation unit presents the cross tabulation result including the number of documents classified into both the first category and the second category, which are generated, out of the documents including the word.

6. A program stored in a non-transitory computer-readable storage medium, the program being executed by a computer of a document analysis apparatus including a document storage unit which stores a plurality of documents each of which includes a text formed from a plurality of words, has a plurality of attributes, and includes attribute values of the attributes, and a pattern storage unit which stores a plurality of patterns each representing presence/absence of a correlation between a word and each of at least two attributes out of the plurality of attributes, the program causing the computer to execute an analysis method, the analysis method comprising:
acquiring a plurality of words by analyzing the text included in each of the plurality of documents stored in the document storage unit;
determining, for each of the acquired words, the presence/absence of the correlation between the word and at least two attributes designated by a user out of the plurality of attributes of the plurality of documents stored in the document storage unit;
determining whether a determination result matches a pattern designated by the user out of the plurality of patterns stored in the pattern storage unit; and
presenting a word whose determination result is determined to match the pattern designated by the user.
